(19) United States
(12) Patent Application Publication
(10) Pub. No.: US 2004/0101666 A1
(43) Pub. Date: May 27, 2004

(54) Inspection contact sheet and method of fabricating the same

(75) Inventors: Kunihiro Tsubosaki, Shinjuku-Ku (JP); Hiroaki Miyazawa, Shinjuku-Ku (JP); Yoichi Hitomi, Shinjuku-Ku (JP); Masahiro Nagata, Shinjuku-Ku (JP); Takahiro Sahara, Shinjuku-Ku (JP); Masahiro Fuse, Shinjuku-Ku (JP)

Correspondence Address: PARKHURST & WENDEL, L.L.P., 1421 PRINCE STREET, SUITE 210, ALEXANDRIA, VA, 22314-2805, US

(73) Assignee: Dai Nippon Prtg. Co., Ltd., Shinjuku-Ku (JP)

(21) Appl. No.: 10/655,617

(22) Filed: Sep. 5, 2003

(30) Foreign Application Priority Data
Sep. 11, 2002 (JP) 2002-265245
Mar. 12, 2003 (JP) 2003-66851

(51) Int. Cl. B32B 3/00

(52) U.S. Cl. 428/209; 427/402; 216/18

(57) ABSTRACT

An inspection contact sheet for electronic device inspection comprises a three-layer base sheet formed by laminating protective films to both the surfaces of an insulating rubber layer, conductive rubber parts having rubber elasticity and penetrating the base sheet perpendicularly to the surfaces of the base sheet. One of the surfaces of the base sheet is provided with contact pads to be brought into contact with the terminals of the electronic device, and the other surface of the base sheet is provided with contact pads to be brought into direct contact with the terminals of an electronic circuit inspecting circuit member or wiring lines. The terminal pads or the wiring lines have an area greater than the sectional area of the conductive rubber parts.

### TECHNICAL FIELD

The present invention relates to an inspection contact sheet for electronic device inspection, i.e., an intermediate connecting sheet, to be used on an electronic device inspecting device and interposed between an electronic device and an electronic device inspecting circuit member to connect the terminals of the electronic device to the terminals of the electronic device inspecting circuit member electrically for the inspection of the electronic device for functions and characteristics, and to a method of fabricating the inspection contact sheet for electronic device inspection.

### BACKGROUND ART

Generally, an electronic device inspecting device having a principal part as shown in FIG. 8 is used for inspecting an electronic device with package leads on a small pitch, such as a semiconductor device, for electrical characteristics, and for testing the electronic device by burn-in.

Referring to FIG. 8, an elastic rubber sheet 860 is held under an electronic device inspecting circuit member 830, and an electronic device 820 is pressed against the wiring line 831 of the electronic device inspecting circuit member 830 with a pressing tool 840. The resilience of the elastic rubber sheet 860 ensures the electric contact between the terminals 821 of the electronic device and the terminals 831a of the electronic device inspecting circuit member 830.

The electronic device inspecting circuit member 830 is connected to a tester, not shown, to analyze the characteristics of the electronic device 820. Only an essential part of the electronic device inspecting circuit member 830 is shown in FIG. 8.

The recent enhancement of the functions and operating speed of electronic devices requires the reduction of noise generated by the electronic device inspecting circuit member and delay in the operation of the electronic device inspecting circuit member during high-speed inspection operations to below permissible levels.

To meet such requirements, the power lines and the grounding lines of the electronic device inspecting circuit member need to be extended in a layer other than a layer provided with signal lines, and hence the electronic device inspecting circuit member is formed necessarily of a multilayer substrate.

The electronic device inspecting circuit member formed of a multilayer substrate is rigid and hence the elastic rubber sheet 860 underlying the electronic device inspecting circuit member 830 in the electronic device inspecting device shown in FIG. 8 is unable to exercise its intrinsic function. Consequently, in some cases, reliable characteristic inspection cannot be attained.

Intermediate connecting sheets as shown in FIGS. 7(a) and 7(b) in partly sectional views are proposed in JP6-60930A and JP6-231818A. These intermediate connecting sheets are used for electrically connecting the terminals of an electronic device to those of an electronic device inspecting circuit member.

An electronic device inspecting circuit member and an electronic device are held and compressed between a fixed table and a pressing tool with the intermediate connecting sheet sandwiched between the electronic device inspecting circuit member and the electronic device to connect the corresponding terminals of the electronic device inspecting circuit member and the electronic device to inspect the functions and characteristics of the electronic device.

An intermediate connecting sheet shown in FIG. 7(a) having the shape of a sheet includes a single layer 710 having rubber elasticity, cured conductive paste layers 720, and Au terminals 731 formed by plating. This intermediate connecting sheet is deficient in mechanical strength, has a very large coefficient of thermal expansion that causes large change in thickness and lateral dimensions. Consequently, the terminals of the intermediate connecting sheet, i.e., an inspection contact sheet, shift relative to the corresponding terminals of the electronic device when the electronic device is subjected to inspection in a high-temperature atmosphere or to a burn-in test, and hence the electronic device cannot be accurately tested.

Since the layer 710 having rubber elasticity is exposed, it is possible that the surfaces of the terminals of the electronic device are contaminated with a low-molecular-weight rubber component.

A base 710a included in intermediate connecting sheet shown in FIG. 7(b) is a three-layer structure (or a two-layer structure) formed by attaching films 711 and 713 (or only a film 711 or 713) having rubber elasticity to the surfaces (the surface) of an insulating film 712 not having rubber elasticity. Since rubber is exposed, it is possible that the surfaces of the terminals of the electronic device are contaminated with a low-molecular-weight rubber component.

Since terminals 735 of a metallic substance formed by a plating process or the like penetrate the base 710a, the terminals 735 do not deform elastically when the same are loaded by bringing the same into contact with the terminals of the electronic device to be tested. Consequently, as the terminals 735 are unable to absorb irregularities in flatness of the terminals of the electronic device, it is difficult to bring all the terminals 735 into contact reliably with the corresponding terminals of the electronic device to achieve an accurate inspection, and accurate voltage application cannot be achieved.

In the electronic device inspecting device as shown in FIG. 8, the sheet 860 having rubber elasticity underlying the electronic device inspecting circuit member 830 is unable to exercise its intrinsic function and, in some cases, reliable characteristic inspection of recent high-function electronic devices capable of high-speed operation cannot be achieved. Thus, there has been desired the development of measures for dealing with such problems. The sheet-shaped intermediate contact members shown in FIGS. 7(a) and 7(b) for electrically connecting the terminals of an electronic device to those of an electronic device inspecting circuit member has various problems and it has been desired to take measures to solve those problems.

### DISCLOSURE OF THE INVENTION

The present invention has been made to solve those problems with an intension to provide a means capable of surely electrically connecting an electronic device to be inspected and an electronic device inspecting circuit member when a highly rigid inspecting-multilayer circuit board must be unavoidably used as the electronic device inspecting circuit member, of withstanding repetitive use, and of being used without causing problems in the quality of the tested electronic device.

More specifically, it is an object of the present invention to provide an inspection contact sheet to be interposed between an electronic device and an electronic device inspecting circuit member, capable of surely electrically connecting the terminals of the electronic device to those of the electronic device inspecting circuit member for inspection and burn-in tests, and to provide a method of fabricating the same inspection contact sheet.

According to the present invention, an inspection contact sheet to be interposed between an electronic device and an electronic device inspecting circuit member to connect the electronic device electrically to the electronic device inspecting circuit member comprises: an insulating rubber layer having rubber elasticity; a pair of insulating protective films bonded to both the surfaces of the insulating rubber layer; conductive rubber parts formed of a conductive rubber-like material having rubber elasticity, and penetrating the insulating rubber layer and the pair of protective films and; and terminal pads or wiring lines connected to the opposite ends of each of the conductive rubber parts.

In the inspection contact sheet according to the present invention, the terminal pads or the wiring lines have an area greater than the sectional area of the conductive rubber parts, and cover the ends of the conductive rubber parts entirely.

In the inspection contact sheet according to the present invention, each of the terminal pads on the side of the electronic device has an inner first metal layer and an outer second metal layer, and the second meal layer is provided with a central recess.

In the inspection contact sheet according to the present invention, through holes penetrating the insulating rubber layer and the pair of protective layers are formed near the conductive rubber parts.

In the inspection contact sheet according to the present invention, the conductive rubber parts are formed of a conductive material prepared by dispersing conductive particles in a silicone rubber, the insulating rubber layer is formed of a silicone rubber, and the insulating protective films are formed of a polyimide resin or a liquid crystalline polymer.

In the inspection contact sheet according to the present invention, the conductive particles are Ag particles.

In the inspection contact sheet according to the present invention, H1>ΔH/b and H2>ΔH/a, where ΔH is a maximum compressive deformation of the inspection contact sheet with respect to the direction of thickness, a is a compressive strain limit for the conductive rubber parts, b is a compressive strain limit for the insulating rubber layer, H1 is the thickness of the insulating rubber layer, and H2 is the height of the conductive rubber parts.

The conductive rubber parts connect the electronic device and the electronic device inspecting circuit member electrically to inspect the electronic device.

A compressive strain limit is a maximum strain of an object in a range of elastic compressive deformation.

A method of fabricating an inspection contact sheet comprises the steps of: forming a five-layer laminated structure having a metal layer, an protective layer, an insulating rubber layer, a protective layer and a metal layer superposed in that order by laminating two-layer structures each consisting of the metal layer for forming terminal pads, and the insulating protective layer to both the adhesive surfaces of the insulating rubber layer, and heating the laminated structure formed by laminating the two-layer structures to both the adhesive surfaces of the insulating rubber layer; forming through holes in the five-layer laminated structure; filling the through holes with a conductive rubber paste and curing the conductive rubber paste filling up the through holes to form conductive rubber parts having rubber elasticity; removing parts of the conductive rubber parts projecting from the surfaces of the five-layer laminated structure by polishing; forming resist films having openings corresponding to the opposite ends of the conductive rubber parts and parts of the metal layers around the opposite ends of the conductive rubber parts; forming laminated films or single-layer films having an etch-resistant metal by plating on the opposite ends of the conductive rubber parts and the exposed parts of the metal layers to form terminal pads or wiring lines; and removing the resist films and removing exposed parts of the metal layers by etching using the terminal pads or the wiring lines as etch-resistant layers.

A method of fabricating an inspection contact sheet according to the present invention comprises the steps of: forming a three-layer laminated structure having an insulating protective layer, an insulating rubber layer having adhesive surfaces, and an insulating protective layer superposed in that order by laminating the insulating protective layers to both the adhesive surfaces of the insulating rubber layer, and heating the laminated structure formed by laminating the insulating protective layers and the insulating rubber layer; forming through holes in the three-layer laminated structure; filling up the through holes with a conductive rubber paste and curing the conductive rubber paste filling up the through holes to form conductive rubber parts having rubber elasticity; removing parts of the conductive rubber parts projecting from surfaces of the three-layer laminated structure by polishing; forming metal layers on both the surfaces of the three-layer laminated structure by a sputtering process or an ion plating process; forming first resist films having first openings on the metal layers, and forming an etch-resistant metal layer on parts of the metal layers corresponding to the first openings of the first resist films by a first electroplating process; removing the first resist films, forming second resist films having second openings, and forming laminated layers each having an outermost etch-resistant metal layer, or a single-layer metal layers by plating on parts of the etch-resistant metal layers corresponding to the second openings to form terminal pads or wiring lines; and removing the second resist films, and removing exposed parts of the metal layers by etching using the terminal pads or the wiring lines as etch-resistant layers.

In the method of fabricating an inspection contact sheet according to the present invention, the conductive rubber paste is prepared by dispersing conductive particles in a silicone rubber, the insulating rubber layer is formed of a silicone rubber, and the insulating protective films are formed of a polyimide resin or a liquid crystalline polymer.

In the method of fabricating an inspection contact sheet according to the present, H1>ΔH/b and H2>ΔH/a, where ΔH is a maximum compressive deformation of the thickness of the inspection contact sheet, a is a compressive strain limit for the conductive rubber parts, b is a compressive strain limit for the insulating rubber layer, H1 is the thickness of the insulating rubber layer, and H2 is the height of the conductive rubber parts.

The electronic device is, for example, a bear chip, a CSP, a BGA, a QFN or a SON.

The terminals of the electronic device may be those having surfaces included in a plane or may be solder balls arranged in a plane.

The inspection contact sheet according to the present invention is a sheet-shaped intermediate connecting sheet to be interposed between the electronic device and the electronic device inspecting circuit member to connect the terminals of the electronic device electrically to those of the electronic device inspecting circuit member. The inspection contact sheet is capable of electrically connecting the electronic device to be inspected and the electronic device inspecting circuit member with reliability.

More concretely, the three-layer structure formed by sandwiching the insulating rubber layer between the insulating protective films is used as a base sheet, and the conductive rubber parts having rubber elasticity are formed perpendicularly to both the surfaces of the base sheet so as to penetrate the base sheet. The terminal pad to be brought into contact with the terminal of the electronic device is formed on one end of each of the conductive rubber parts, and the terminal pad or the wiring line to be brought into contact with the terminal of the electronic device inspecting circuit member is formed on the other end of the same rubber-elastic conductive rubber part. The terminal pad or the wiring line is formed so as to cover the corresponding end of the conductive rubber part entirely and to cover a part of the metal layer around the same end of the conductive rubber part, and has an area greater than that of the end of the conductive rubber part. The electronic device is connected electrically to the electronic device inspecting circuit member through the conductive rubber parts and the terminal pads or the wiring lines formed on the opposite ends of the conductive rubber parts.

More specifically, the conductive rubber parts are formed of the conductive rubber-like material having rubber elasticity. The terminals of the electronic device and those of the electronic device inspecting circuit member are connected electrically to the opposite ends of the conductive rubber parts extending across the inspection contact sheet, respectively, and the electronic device and the electronic device inspecting circuit member are connected electrically through the conductive rubber parts. When forces are applied to the opposite ends of each of the conductive rubber part to inspect the electronic device or to test the electronic device by a burn-in test, the conductive rubber part and parts of the insulating rubber layer around the conductive rubber part deform elastically, so that the electronic device and the electronic device inspecting circuit member can be surely electrically connected even if the terminals of the electronic device are irregular in flatness or the terminals of the electronic device inspecting circuit member are irregular in flatness.

Each of the terminal pads to be brought into contact with the terminals of the electronic circuit is provided with the central recess. Therefore, when an electronic device provided with solder ball terminals is subjected to inspection or burn-in, the solder ball terminals are forced to drop into the central recesses of the terminal pads even if the terminals of the electronic device are dislocated from correct positions relative to the terminal pads of the inspection contact sheet.

In the inspection contact sheet according to the present invention, through holes penetrating the insulating rubber layer and the pair of protective layers are formed near the conductive rubber parts. The through holes reduce and permit the conductive rubber parts and the insulating rubber layer to expand in parallel to the surfaces of the base sheet when a force is applied to the terminal pads or the wiring lines corresponding to the conductive rubber parts. Thus, the conductive rubber parts can be compressed in a direction perpendicular to the base sheet by a lower force.

Particularly, since the elastic, conductive rubber-like material having rubber elasticity and forming the conductive rubber parts is prepared by dispersing the conductive particles in a synthetic rubber, and the inspection contact sheet meets the conditions: H1>ΔH/b and H2>ΔH/a, where ΔH is a design maximum compressive deformation of the inspection contact sheet with respect to the direction of thickness, a is a compressive strain limit for the conductive rubber parts, b is a compressive strain limit for the insulating rubber layer, H1 is the thickness of the insulating rubber layer, and H2 is the height of the conductive rubber parts, ΔH/H1<b (ΔH/H1 is the compressive strain of the insulating rubber layer) and ΔH/H2<a (ΔH/H2 is the compressive strain of the conductive rubber part). Thus, the insulating rubber layer and the conductive rubber parts maintain rubber elasticity even if the same are subjected repeatedly to the compressive deformation of ΔH, and hence the inspection contact sheet has a long life.

Since the modulus of elasticity of rubber is very small and stands no comparison with those of metals, the terminals of the electronic device can be kept in contact with the conductive rubber parts by a low force and hence the solder balls of the electronic device will not be deformed.

The insulating rubber layer and the conductive rubber parts are covered with the insulating protective films and the terminal pads or the wiring lines. Therefore, it is possible to prevent the migration of a low-molecular-weight rubber component of the rubber from the insulating rubber layer and the conductive rubber parts to the surfaces of the terminals of the electronic device to be inspected, and the resultant contamination of the surfaces of the terminals of the electronic device with the materials forming the insulating rubber layer and the conductive rubber parts.

If the electronic device is a bear chip, such contamination is particularly detrimental and hence it is particularly effective to use the inspection contact sheet for inspecting bear chips.

The insulating protective films, as compared with the insulating rubber layer, have a high mechanical strength and a small coefficient of thermal expansion. Therefore, the thermal deformation of the insulating protective films is small even in a hot atmosphere, and hence the terminals of the inspection contact sheet are not dislocated relative to the corresponding terminals of the electronic device.

Generally, the elastic member having rubber elasticity has a low breaking strength, and hence bond strength acting between the elastic member and a metal member is comparatively low even if the elastic member is bonded closely to the metal member. In the inspection contact sheet of the present invention, peripheral parts of the terminal pads or the wiring lines are firmly bonded to the protective films, a high bond strength acts on the terminals, and hence the terminal pads or the wiring lines will not break even if the same are stressed repeatedly.

The inspection contact sheet of the present invention is particularly effective in application to inspecting electronic devices provided with inelastic terminals, such as bear chips, SCPs, BGAs, QFNs and SONs.

The method of fabricating an inspection contact sheet according to the present invention forms the inspection contact sheet serving as an intermediate connecting sheet interposed between an electronic device and an electronic device inspecting circuit member to connect the electronic device and the electronic device inspecting circuit member electrically, and capable of surely electrically connecting the electronic device to be inspected and the electronic device inspecting circuit member.

In the inspection contact sheet according to the present invention, slits are formed in the insulating protective film on the side of the electronic device so as to surround the terminal pads.

In the inspection contact sheet according to the present invention, the terminal pads or the wiring lines have an area greater than the sectional area of the conductive rubber parts and cover the conductive rubber parts entirely.

In the inspection contact sheet according to the present invention, the conductive rubber parts are formed of a conductive material prepared by dispersing conductive particles in a silicone rubber, and the insulating rubber layer is formed of a silicone rubber.

In the inspection contact sheet according to the present invention, the conductive particles are Ag particles.

In the inspection contact sheet according to the present invention, H1>ΔH/b and H2>ΔH/a, where ΔH is a maximum compressive deformation of the inspection contact sheet with respect to the direction of thickness, a is a compressive strain limit for the conductive rubber parts, b is a compressive strain limit for the insulating rubber layer, H1 is the thickness of the insulating rubber layer, and H2 is the height of the conductive rubber parts.

In the inspection contact sheet according to the present invention, each of the terminal pads on the side of the electronic device is provided with a central recess.

In the inspection contact sheet according to the present invention, the electronic device is a BGA or a SCP provided with solder ball terminals.

A method of fabricating an inspection contact sheet according to the present invention comprises the steps of: forming a five-layer laminated structure having a metal layer, a protective film, an insulating rubber layer, a protective film and a metal layer superposed in that order by laminating two-layer structures each consisting of the metal layer for forming terminal pads, and the insulating protective layer to both the adhesive surfaces of the insulating rubber layer, and heating the laminated structure formed by laminating the two-layer structures to both the adhesive surfaces of the insulating rubber layer; forming through holes in the laminated structure; filling the through holes with a conductive rubber paste and curing the conductive rubber paste filling up the through holes to form conductive rubber parts having rubber elasticity; removing parts of the conductive rubber parts projecting from the surfaces of the laminated structure by polishing; forming additional metal layers on the metal layers, respectively, by a plating surface; forming resist films covering only parts for forming terminal pads or wiring lines of the additional metal layers, and removing exposed parts of the additional metal layers and the metal layers by etching; removing the resist films, and forming surface layers on the surfaces of the parts for forming the terminal pads or wiring lines of the additional metal layers by an electroless plating process; and forming slits around the terminal pads to be brought into contact with the terminals of the electronic device in the protective films by laser machining.

The electronic device inspecting circuit member may be other than the electronic device inspecting circuit member 830 used for inspecting an electronic device 820 for functions and characteristics by holding and compressing the electronic device inspecting circuit member 830 and the electronic device 820 between a fixed table 850 and a pressing tool 840 so that the electronic device 820 is connected electrically to the electronic device inspecting circuit member 830 as shown in FIG. 8, and an electronic device inspecting circuit member 530 as shown in FIG. 10.

For example, an electronic device inspecting circuit member 930 provided with wiring lines 931 and a socket 941 as shown in FIG. 16 may be employed for electronic device inspection.

As shown in FIG. 16, the terminal pads or the wiring lines of an inspection contact sheet 910 are brought into contact with ends of the pins 950 to connect the inspection contact sheet electrically to the electronic device inspecting circuit member 930.

Latching members of a clasp 943 are engaged to hold and compress a semiconductor device 920 and the inspection contact sheet 910 between the socket 941 and a pressing member 942.

Shown in FIG. 16 are terminals (solder balls) 921, wiring lines 931, and pins 944 and 945.

The inspection contact sheet of the present invention thus formed is a sheet-shaped intermediate connecting sheets to be placed between the electronic device and the electronic device inspecting circuit member to connect the terminals of the electronic device electrically to the terminal pads of the electronic device inspecting circuit member. The inspection contact sheet is capable of surely electrically connecting the electronic device to be inspected and the electronic device inspecting circuit member and of withstanding repetitive use, and is excellent in quality.

The inspection contact sheet is capable of solving problems that arise when solder balls of different sizes serving as terminals are arranged at small pitches, and small solder balls adjacent to large solder balls have difficulty in coming into contact with the terminals of the inspection contact sheet.

More concretely, a three-layer laminated sheet formed by bonding insulating protective films to both the surfaces of an insulating rubber layer is used as the base sheet, the conductive rubber parts having rubber elasticity are formed so as to penetrate the base sheet perpendicularly to the surfaces of the base sheet, the terminal pads to be brought into contact with the terminals of an electronic device are formed on one of the surfaces of the base sheet, and terminal pads or wiring lines to be brought into contact with the terminals of the inspection circuit device are formed on the other surface of the base sheet. The terminal pads or the wiring lines are electrically connected to the conductive rubber parts. The electronic device is connected electrically to the electronic device inspecting circuit member through the conductive rubber parts and the terminal pads or the wiring lines formed on the opposite ends of the conductive rubber parts when the electronic device is subjected to inspection of burn-in. The terminal pads to be brought into contact with the terminals of the electronic device are surrounded by continuous or broken slits, respectively.

More specifically, when forces are applied to the surfaces of the inspection contact sheet and the inspection contact sheet is compressed to inspect the electronic device or to subject the electronic device to a burn-in test, the insulating rubber layer and/or the conductive rubber parts deform elastically, so that irregularity in flatness of the terminals of the electronic device and the electronic device inspecting circuit member can be absorbed. The continuous or broken slits formed in the protective film on the side of the electronic device so as to surround the terminal pads prevent the terminal pads from being affected by the condition of the adjacent terminal pads.

Generally, the elastic member having rubber elasticity has a low breaking strength, and hence bond strength acting between the elastic member and a metal member is comparatively low even if the elastic member is bonded closely to the metal member. In the inspection contact sheet of the present invention, peripheral parts of the terminal pads or the wiring lines are firmly bonded to the protective films, a high bond strength acts on the terminals, and hence the terminal pads or the wiring lines will not break even if the same are stressed repeatedly.

The conductive rubber-like material is prepared by diffusing conductive particles, such as Ag particles in a silicone rubber. The insulating rubber layer is formed of a silicone rubber.

Since the inspection contact sheet meets the conditions: H1>ΔH/b and H2>ΔH/a, where ΔH is a design maximum compressive deformation of the inspection contact sheet with respect to the direction of thickness, a is a compressive strain limit for the conductive rubber parts, b is a compressive strain limit for the insulating rubber layer, H1 is the thickness of the insulating rubber layer, and H2 is the height of the conductive rubber parts, the insulating rubber layer and the conductive rubber parts maintain rubber elasticity even if the same are subjected repeatedly to the compressive deformation of ΔH, and hence the inspection contact sheet has a long life.

Since the modulus of elasticity of rubber is very small and stands no comparison with those of metals, the terminals of the electronic device can be kept in contact with the conductive rubber parts by a low force and hence the solder balls of the electronic device will not be deformed.

Each of the terminal pads to be brought into contact with the terminals of the electronic circuit is provided with the central recess. Therefore, the terminal pads of the inspection contact sheet to be brought into contact with the terminals of the electronic device move according to the position of the terminals of the electronic device particularly when the terminals of the electronic device are solder ball terminals, so that the solder ball terminals can be properly received in the recesses.

The inspection contact sheet of the present invention is capable of being used for the inspection of a BGA or CSP provided with solder ball terminals arranged at small pitches.

The inspection contact sheet according to the present invention is capable of effectively coping with irregularity in flatness of the terminals of the electronic device due to the warping of the package, and is applicable to the inspection of electronic devices not provided with solder ball terminals, such as LGAs and QFNs.

The insulating rubber layer and the conductive rubber parts are covered with the insulating protective films and the terminal pads. Therefore, it is possible to prevent the migration of a low-molecular-weight rubber component of the rubber from the insulating rubber layer and the conductive rubber parts to the surfaces of the terminals of the electronic device to be inspected, and the resultant contamination of the surfaces of the terminals of the electronic device with the materials forming the insulating rubber layer and the conductive rubber parts.

If the electronic device is a bear chip and the rubber component is a silicone rubber, such contamination is particularly detrimental.

The insulating protective films, as compared with the insulating rubber layer, have a high mechanical strength and a small coefficient of thermal expansion. Therefore, the thickening thermal deformation of the insulating protective films is small even in a hot atmosphere, and hence the terminals of the inspection contact sheet are not dislocated relative to the corresponding terminals of the electronic device.

### BRIEF DESCRIPTION OF THE DRAWINGS

FIGS. 1(a) and 1(b) are views of an inspection contact sheet in Type 1-1 in a first embodiment according to the present invention for electronic device inspection;

FIG. 2 is a view of an inspection contact sheet in Type 1-2 in the first embodiment for electronic device inspection;

FIGS. 3(a) to 3(c)are views of an inspection contact sheet in Type 1-3 in the first embodiment for electronic device inspection;

FIGS. 4(a) to 4(g) are sectional views of assistance in explaining steps of a method of fabricating the inspection contact sheet in Type 1-1 shown in FIGS. 1(a) and 1(b);

FIGS. 5(a) to 5(e) are views of assistance in explaining steps of a method of fabricating the inspection contact sheet in Type 1-3 shown in FIGS. 3(a) and 3(b);

FIGS. 6(f) to 6(h) are views of assistance in explaining steps, following those shown in FIGS. 5(a) to 5(e) of the method of fabricating the inspection contact sheet in Type 1-3 shown in FIGS. 3(a) and 3(b);

FIGS. 7(a) and 7(b) are partly sectional views of a conventional inspection contact sheet;

FIG. 8 is a schematic partly sectional view of a conventional electronic device inspecting device for inspecting an electronic device for electrical characteristics;

FIGS. 9(a) and 9(b) are views of Type 2-1 of an inspection contact sheet in a second embodiment according to the present invention for electronic device inspection;

FIG. 10 is a schematic sectional view showing the inspection contact sheet shown in FIGS. 9(a) and 9(b) in use on an electronic device inspecting device;

FIG. 11 is a partly sectional view of an inspection contact sheet in a modification of the inspection contact sheet embodying the present invention for electronic device inspection;

FIGS. 12(a) to 12(e) are views of terminal pads surrounded by slits;

FIGS. 13(a) and 13(b) are views of assistance in explaining a mode of contact between the terminals of the inspection contact sheet in Type 2-1 shown in FIGS. 9(a) and 9(b) and the solder balls of an electronic device;

FIGS. 14(a) to 14(e) are views of assistance in explaining steps of a method of fabricating the inspection contact sheet in Type 2-1 shown in FIGS. 9(a) and 9(b);

FIGS. 15(a) to 15(c) are views of assistance in explaining steps of the method of fabricating the inspection contact sheet in Type 2-1 shown in FIGS. 9(a) and 9(b);

FIG. 16 is a view of an inspection contact sheet as mounted on a socket included in an electronic device inspecting circuit member; and

FIGS. 17(a) to 17(c) are views of assistance in explaining faulty contact between the terminals of an inspection contact sheet in a comparative example, and the terminals of an electronic device.

### BEST MODE FOR CARRYING OUT THE INVENTION

### First Embodiment

An inspection contact sheet for electronic device inspection (hereinafter, referred to simply as “inspection contact sheet”) in a first embodiment according to the present invention will be described with reference to the accompanying drawings.

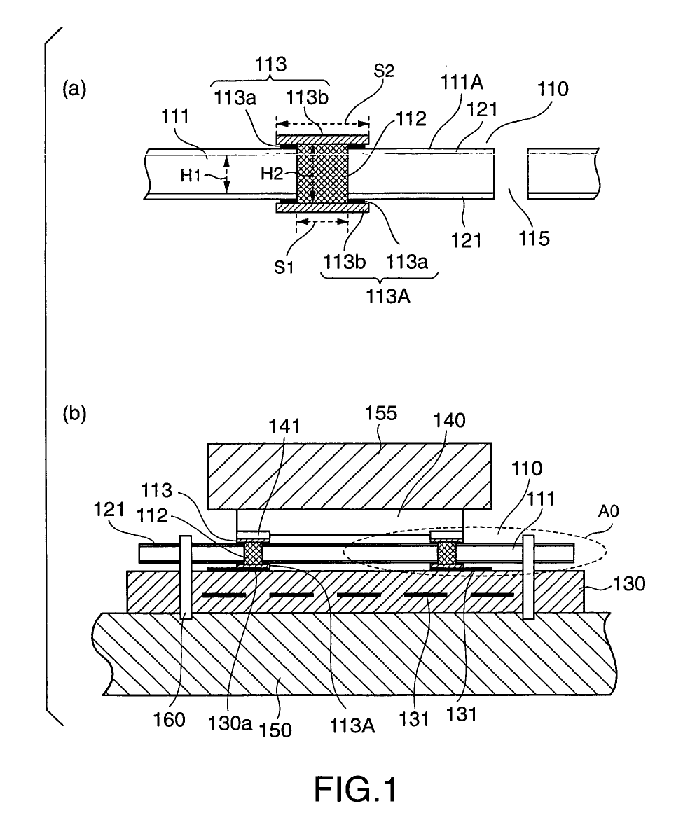

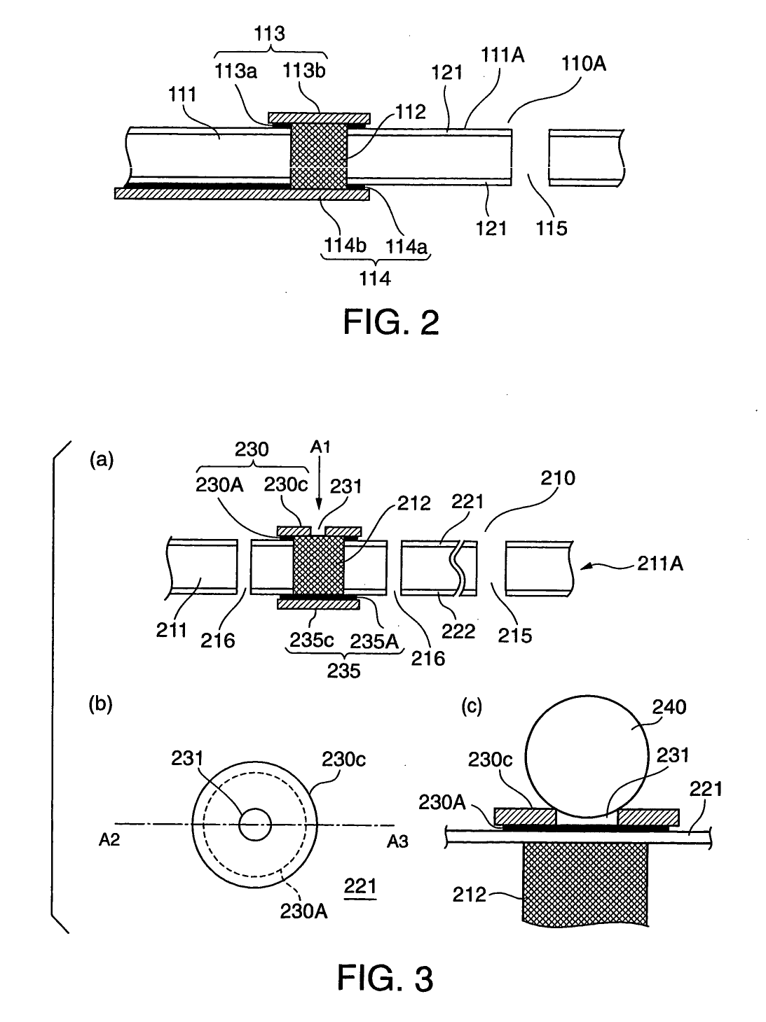

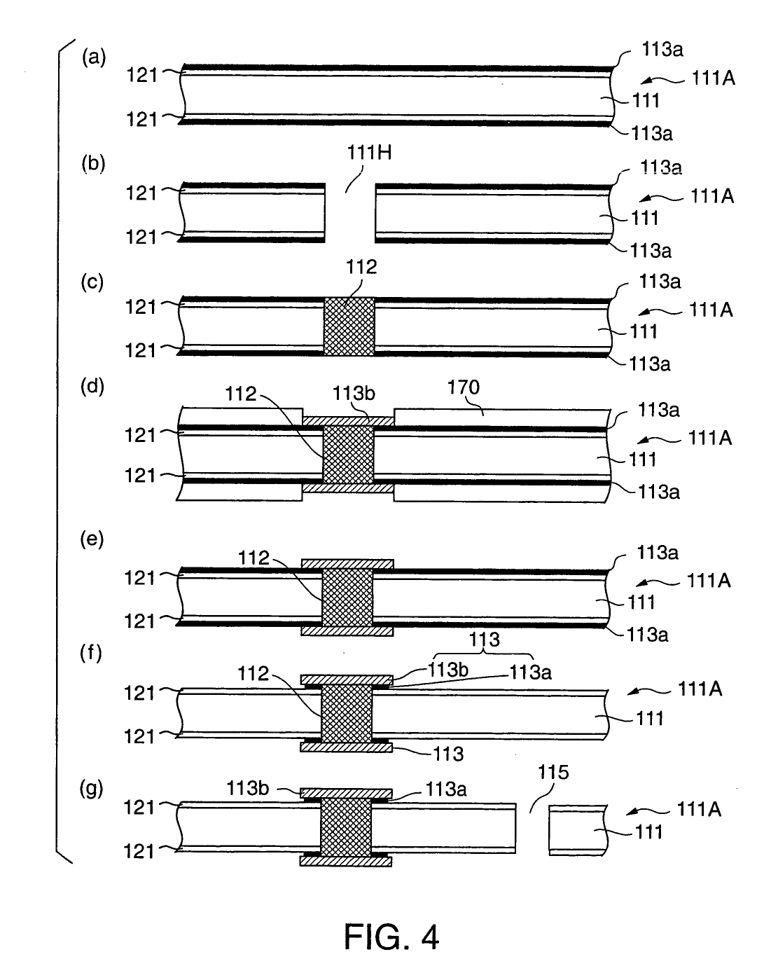

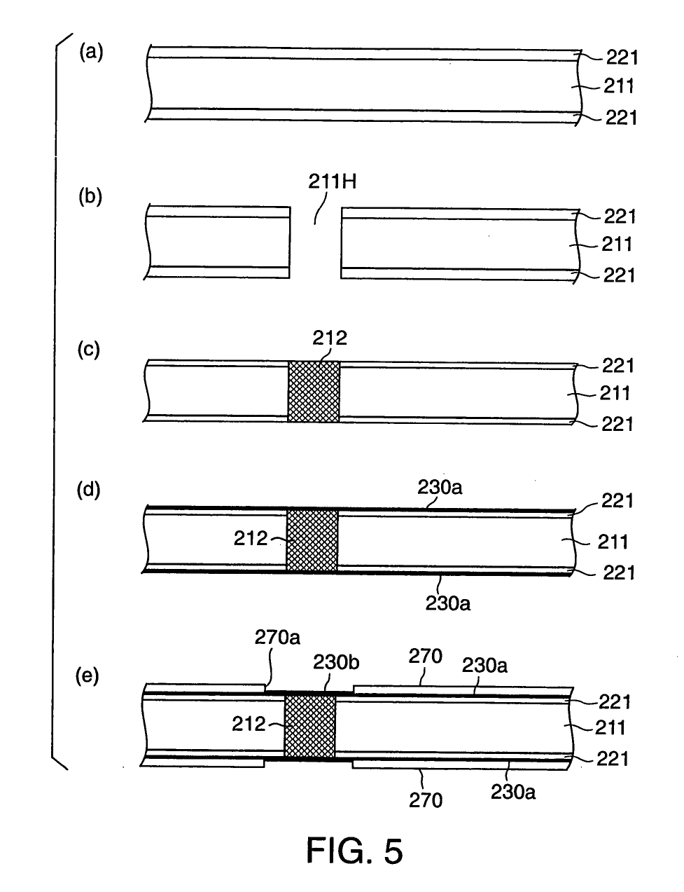

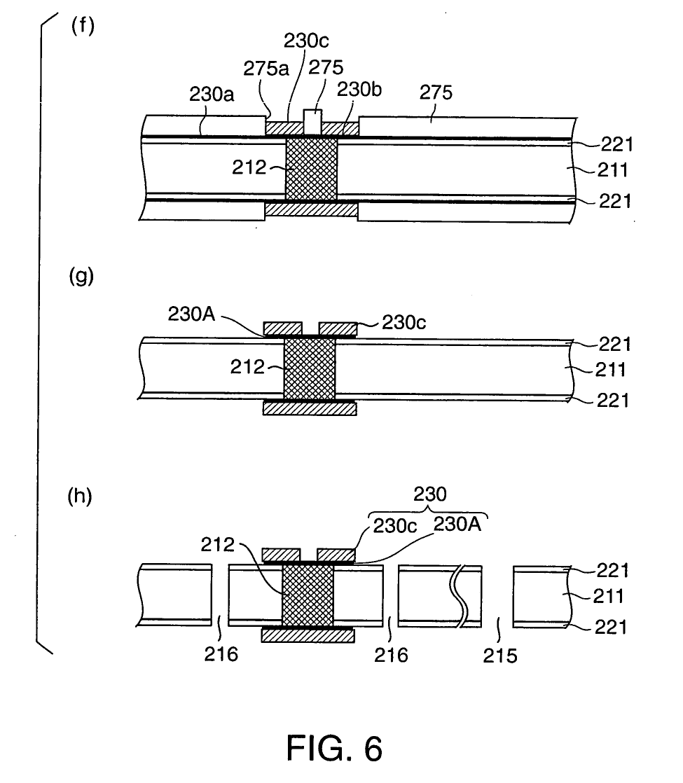

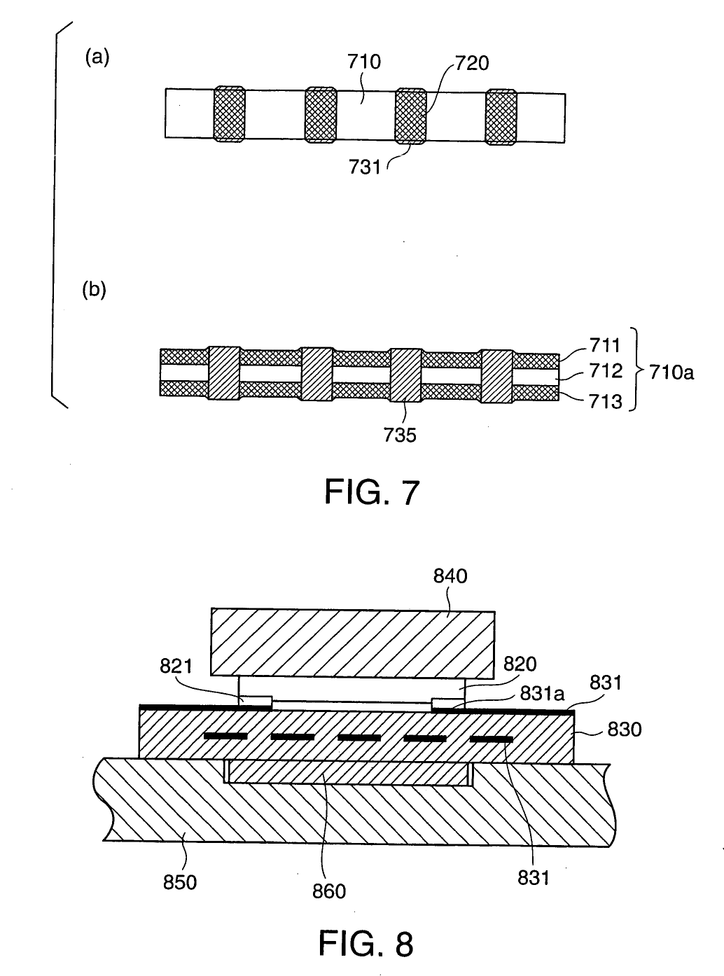

FIG. 1(a) is a partly sectional view of an inspection contact sheet in Type 1-1 in a first embodiment according to the present invention, FIG. 1(b) is a schematic sectional view of the inspection contact sheet shown in FIG. 1(a) in use on an electronic device inspecting device, FIG. 2 is a partly sectional view of an inspection contact sheet in Type 1-2 in the first embodiment for electronic device inspection, FIG. 3(a) is a partly sectional view of an inspection contact sheet in Type 1-3 in the first embodiment for electronic device inspection, FIG. 3(b) is an enlarged view of a terminal pad shown in FIG. 3(a) to be brought into contact with a terminal of an electronic device as viewed in the direction of the arrow A1, FIG. 3(c) is a view of a terminal pad shown in FIG. 3(a) to be brought into contact with a terminal of an electronic device in a state in contact with a solder ball, FIGS. 4(a) to 4(g) are sectional views of assistance in explaining steps of a method of fabricating the inspection contact sheet in Type 1-1 in the first embodiment shown in FIG. 1(a), FIGS. 5(a) to 5(e) are views of assistance in explaining steps of a method of fabricating the inspection contact sheet in Type 1-3 in the first embodiment shown in FIG. 3(a), FIGS. 6(f) to 6(h) are views of assistance in explaining steps, following those shown in FIGS. 5(a) to 5(e), of the method of fabricating the inspection contact sheet in Type 1-3 in the first embodiment shown in FIG. 3(a), FIGS. 7(a) and 7(b) are partly sectional views of a conventional inspection contact sheet, and FIG. 8 is a schematic sectional view of assistance in explaining a conventional electronic device inspecting method and a conventional electronic device inspecting device.

FIG. 1(a) is an enlarged view of a part A0 in FIG. 1(b).

Shown in FIGS. 1 to 6 are inspection contact sheets 110 and 110A for electronic device inspection, an insulating rubber layer (referred to also as “insulating rubber sheet”) 111, a through hole 111H, a conductive rubber part (referred to also as “conductive rubber plug”) 112, a terminal pad 113 to be brought into contact with a terminal of an electronic device, a terminal pad 113A to be brought into contact with a terminal of an electronic device inspecting circuit member, a metal layer 113a, such as a Cu foil, a metal layer 113b, a wiring line 114, a metal layer 114a, a metal layer 114b, a locating hole 115 for a locating jig, an insulating protective film (referred to also as “insulating resin layer”) 121, an electronic device inspecting circuit member 130, a wiring line 131, a terminal pad 130a, an electronic device 140, a terminal 141, a fixed table 150, a pressing tool 155, a locating pin 160, a resist film 170, an inspection contact sheet 210 for electronic device inspection, an insulating rubber layer 211, a through hole 211H, a conductive rubber part (referred to also as “conductive rubber plug”) 212, a locating hole 215, a through hole 216, an insulating protective layer (referred to also as “insulating resin layer”) 221, a terminal pad 230, a metal layer 230a consisting of Cr and Cu layers, a Ni layer 230b, a metal layer (referred to also as “first metal layer”) 235A consisting of the Cr layer, the Cu layer and the Ni layer, a metal layer (referred to also as “second metal layer”) 235c, a solder ball 240, a first resist pattern 270, and a second resist pattern 275.

The inspection contact sheet 110 in Type 1-1 in the first embodiment for electronic device inspection will be described with reference to FIG. 1.

The inspection contact sheet 110 in the first embodiment is used on an electronic device inspecting device that holds and compresses the electronic device inspecting circuit member 130 and the electronic device 140 between the fixed table 150 and the pressing tool 155 to connect the electronic device 140 electrically to the electronic device inspecting circuit member 130 for the inspection of the functions and characteristics of the electronic device 140 or for the burn-in test of the electronic device 140. The inspection contact sheet 110 is an intermediate connecting sheet to be interposed between the electronic device 140 and the electronic device inspecting circuit member 130 for the electrical connection of the electronic device and the electronic device inspecting circuit member 130.

Referring to FIG. 1(a), the inspection contact sheet 110 comprises a base sheet 111A of three-layer construction including the insulating rubber layer 111 and the insulating protective films 121 covering both the surfaces of the insulating rubber layer 111, and conductive rubber parts 112 having rubber elasticity formed of a rubber-elastic material, extending perpendicularly to the surfaces of the base sheet 111A and penetrating the base sheet 111A. Each conductive rubber part 112 has one end connected to the terminal pad 113 to be connected to a terminal of the electronic device 140, and the other end connected to the terminal pad 113A to be connected to a terminal of the electronic device inspecting circuit-member 130. The terminal pads 113 and 113A are connected electrically to the conductive rubber part 112, have areas larger than those of the ends of the conductive rubber part 112, and are capable of covering the ends of the conductive rubber part 112 and areas surrounding the ends of the conductive rubber part 112.

When subjecting the electronic device 140 to inspection or a burn-in test, the terminal pads 113, to be connected to the terminals of the electronic device 140, of the conductive rubber parts 112 are electrically connected to the terminals 141 of the electronic device 140, the other terminal pads 113A are electrically connected to the terminals of the electronic device inspecting circuit member 130. Thus, the electronic device 140 is connected electrically through the terminal pads 113 and 113A to the electronic device inspecting circuit member 130.

The insulating rubber layer 111 is formed of, for example, a silicone rubber. The insulating rubber layer 111 may be formed of any suitable material other than the silicone rubber.

Materials suitable for forming the insulating rubber layer 111 include fluororubbers, urethane rubbers, polybutadiene rubbers, and polyisoprene rubbers.

Preferable materials for forming the insulating protective films 121 are polyimide resins and liquid crystalline polymers.

An elastic rubber-like material having rubber elasticity for forming the conductive rubber parts 112 is prepared by dispersing conductive particles in a synthetic rubber. For example, the conductive rubber parts 112 are formed of a cured silver paste containing a silicone rubber as a base material. The conductive rubber parts 112 may be made from any other suitable materials.

Preferably, each conductive part 112 has a resistance of 100 mΩ or below.

The metal layers 113a and 113b may be either a single-layer structure or a multilayer structure, and may be formed of any suitable materials. The construction and the material of the metal layers 113 and 113b are selectively determined depending on a method of forming the same.

For example, when the inspection contact sheet 110 is fabricated by an inspection contact sheet fabricating method illustrated in FIG. 4, the metal layer 113a is formed of a Cu foil, and the metal layer 113b is formed by depositing a plated Cu layer, a plated Ni layer, and an etch-resistant plated Au layer in that order from the bottom upward.

When the inspection contact sheet meets conditions: H1>ΔH/b and H2>ΔH/a, where ΔH is a design maximum compressive deformation of the inspection contact sheet 110 with respect to thickness, a is a compressive strain limit for the conductive rubber parts, b is a compressive strain limit for the insulating rubber layer, H1 is the thickness of the insulating rubber layer, and H2 is the height of the conductive rubber parts, ΔH/H1<b (ΔH/H1 is the compressive strain of the insulating rubber layer) and ΔH/H2<a (ΔH/H2 is the compressive strain of the conductive rubber part). Thus, the insulating rubber layer and the conductive rubber parts are strained for compressive strains below the compressive strain limits, maintain rubber elasticity even if the same are subjected repeatedly to the compressive deformation of ΔH.

In FIG. 1, the area S2 of the terminal pads 113 is larger than the area S1 of the conductive rubber parts 112, and, generally, b>a.

The inspection contact sheet 110A in Type 1-2 in the first embodiment will be described with reference to FIG. 2.

The inspection contact sheet 110A, similarly to the inspection contact sheet 110 in Type 1-1, is used on an electronic device inspecting device that holds and compresses the electronic device inspecting circuit member 130 and the electronic device 140 between the fixed table 150 and the pressing tool 155 to connect the electronic device 140 electrically to the electronic device inspecting circuit member 130 for the inspection of the functions and characteristics of the electronic device 140 or for the burn-in test of the electronic device 140. The inspection contact sheet 110A is an intermediate connecting sheet to be interposed between the electronic device 140 and the electronic device inspecting circuit member 130 for the electrical connection of the electronic device and the electronic device inspecting circuit member 130. The inspection contact sheet 110A in Type 1-2 is provided with wiring lines 114 instead of the terminal pads 113A of the inspection contact sheet 110 in Type 1-1 to connect the conductive rubber parts 112 electrically to the electronic device inspecting circuit member at increased terminal pitches. The inspection contact sheet 110A in Type 1-2 is similar in other respects to the inspection contact sheet 110 in Type 1-1.

Materials used for forming the inspection contact sheet 110A are the same as those used for forming the inspection contact sheet 110, and hence the description of the materials will be omitted.

The inspection contact sheet 210 in Type 1-3, similarly to the inspection contact sheet 110 in Type 1-1, is used on an electronic device inspecting device that holds and compresses the electronic device inspecting circuit member 130 and the electronic device 140 between the fixed table 150 and the pressing tool 155 to connect the electronic device 140 electrically to the electronic device inspecting circuit member 130 for the inspection of the functions and characteristics of the electronic device 140 or for the burn-in test of the electronic device 140. The inspection contact sheet 210 is interposed between the electronic device 140 and the electronic device inspecting circuit member 130 for the electrical connection of the electronic device and the electronic device inspecting circuit member 130. The inspection contact sheet 210 in Type 1-3 is provided with terminal pads 230 different in shape from the terminal pads 113 of the inspection contact sheet 110 in Type 1-1. Each terminal pad 230 consists of a first metal layer 230A and a second metal layer 230C. As shown in FIG. 3(b), a recess 231 is formed in a part, corresponding to the end of the conductive rubber part 212, of the second metal layer 230c. The first and the second metal layer may be multilayer metal layer.

There are not particular restrictions on the construction of the first and the second metal layer, materials for forming the first and the second layer, and a method of forming the same. In some cases, there are some restrictions on the method of fabricating the first and the second metal layer, which will be explained afterward.

When the inspection contact sheet 210 is fabricated by a method shown in FIGS. 5 and 6, the first metal layer 230A is a laminated structure formed by laminating a sputtered Cr layer, a sputtered Cu layer, and an etch-resistant plated Ni layer, and the second metal layer 230c is a laminated structure formed by laminating a plated Ni layer, and an etch-resistant plated Pd layer.

A method of fabricating the inspection contact sheet 110 in Type 1-1 shown in FIG. 1 will be described in brief with reference to FIG. 4 by way of example.

An elastic sheet including the insulating rubber layer 111 is formed. Two two-layer laminated sheets each formed by laminating the metal layer 113a, such as a Cu foil, and the insulating resin layer 121, i.e., the insulating protective film, are laminated to both the surfaces of the elastic sheet to form a laminated structure, and then the laminated structure is subjected to curing. The insulating resin layers 121 are bonded to the insulating rubber layer 111, i.e., the elastic sheet as shown in FIG. 4(a).

Thus, the base sheet 111A, i.e., a five-layer laminated base sheet, consisting of the insulating rubber layer 111 and the laminated insulating sheets including the insulating resin layers 121 is formed.

The metal layers 113a are processed later to form the metal layers 113a of the terminal pads 113 and 113A shown in FIG. 1.

Generally, the two-layer laminated sheet is formed by laminating a metal layer 113a, such as a Cu foil, and am insulating resin layer 121, such as a polyimide resin layer or a liquid crystalline polymer layer.

Then, the through holes 111H are formed in parts of the five-layer laminated base sheet 111A in which the conductive rubber parts are to be formed as shown in FIG. 4(b).

Usually, the through holes 111H are formed by laser machining using a laser, such as a UV-YAG laser.

Then, the through holes 111H are filled up with a conductive rubber paste by a screen printing method, a metal mask printing method or a squeegee printing method. The conductive rubber paste filling up the through holes 111H is heated for curing to form cured conductive rubber parts. Parts of the cured conductive rubber parts projecting from the surfaces of the base sheet 111A are removed by polishing, and the surfaces of parts of the Cu foils, i.e., the metal layers 113a, around the cured conductive rubber parts are polished as shown in FIG. 4(c).

The conductive rubber paste for forming the conductive rubber parts 112 shown in FIG. 1(a) is prepared by dispersing conductive particles in an elastic synthetic rubber.

The conductive rubber paste is, for example, a silver paste containing a silicon rubber as a base material. Any suitable conductive rubber pastes other than the silver paste may be used.

Thus, the conductive rubber parts 112 shown in FIG. 1(a) are formed.

The opposite end surfaces of each conductive rubber part 112 are flush with the surfaces of the metal layers 113a, respectively.

Subsequently, dry resist films 170 are formed over the metal layers 113a, respectively, the dry resist films 170 are subjected to an exposure process and a developing process to form openings coinciding with regions, in which the terminal pads or the wiring lines are to be formed, in the dry resist films 170. Then, the base sheet 111A is subjected sequentially to a Cu electroplating process, a Ni electroplating process and an Au electroplating process using the metal layers 113a as electrodes to form a plated Cu layer, a plated Ni layer and a plated Au layer in that order on exposed parts of the Cu foils, i.e., the metal layers 113a, in the openings in the dry resist films, and on the opposite end surfaces of the conductive rubber parts 112 to form the terminal pads 113 as shown in FIG. 4(d). Then, the resist films 170 are removed as shown in FIG. 4(e), and the exposed parts of the Cu foils, i.e., the metal layers 113a, are removed as shown in FIG. 4(f) by etching using the plated Au layers as etch-resistant layers.

An alkaline ammonium persulfate solution capable of dissolving Cu and incapable of dissolving Ni is used for etching the Cu foils.

Then the base sheet 111A is subjected to a punching process for shaping to obtain the inspection contact sheet 110 shown in FIG. 1(a) (FIG. 4(g)).

The inspection contact sheet 110 in the first embodiment shown in FIG. 1(a) is thus fabricated.

When fabricating the inspection contact sheet 110A shown in FIG. 2, the method shown in FIG. 4 needs to change only the shapes of the openings formed in the resist film 170.

A method of fabricating the inspection contact sheet 210 in Type 1-3 shown in FIG. 3 will be described with reference to FIGS. 5 and 6. In the inspection contact sheet 210, the insulating resin layers 221 are liquid crystalline polymer layers.

The insulating resin layers 221, i.e., the liquid crystalline polymer layers, are laminated to the adhesive surfaces of the insulating rubber layer 211, the assembly of the insulating resin layers 221 and the insulating rubber layer 211 is heated to form a base sheet 211A, i.e., a three-layer laminated structure consisting of the liquid crystalline polymer layer, the insulating rubber layer and the liquid crystalline polymer layer as shown in FIG. 5(a).

Usually, the insulating rubber layer 211 is a silicone rubber sheet.

Then, the through holes 211H are formed in parts of the three-layer laminated base sheet 211A in which the conductive rubber parts are to be formed as shown in FIG. 5(b).

Usually, the through holes 211H are formed by laser machining using a laser, such as a CO₂ laser.

Then, the through holes 211H are filled up with a conductive rubber paste by a screen printing method, a metal mask printing method or a squeegee printing method. The conductive rubber paste filling up the through holes 111H is cured to form cured conductive rubber parts. Parts of the cured conductive rubber parts projecting from the surfaces of the base sheet 211A are removed by polishing, and the surfaces of parts of the insulating resin layers 221, i.e., the liquid crystalline polymer layers, around the cured conductive rubber parts are polished flat as shown in FIG. 5(c).

The conductive rubber paste for forming the conductive rubber parts 212 shown in FIG. 3(a) is prepared by dispersing conductive particles in an elastic synthetic rubber.

The conductive rubber paste is, for example, a silver paste containing a silicon rubber as a base material. Any suitable conductive rubber pastes other than the silver paste may be used.

Thus, the conductive rubber parts 212 shown in FIG. 3(a) are formed.

Then, the metal layers 230a each consisting of a Cr layer and a Cu layer overlying the Cr layer are formed on both the surfaces of the three-layer laminated structure by a sputtering process or an ion plating process as shown in FIG. 5(d).

The metal layers 230a each consisting of the Cr and the Cu layer are used as electrodes for electroplating, and serve for firmly bonding the terminal pads 230 and 235 to the liquid crystalline polymer and to the conductive rubber parts 212.

First resist patterns 270 having openings 270a respectively corresponding to regions in which the terminal pads or the wiring lines are to be formed are formed over the Cu layers of the metal layers 230a by ion plating, and the Ni layers 230b are formed on exposed parts of the Cu layers in the openings 270a by Ni electroplating as shown in FIG. 5(e).

Then, the first resist patterns 270 are removed, and second resist patterns 275 provided with openings 275a of a predetermined shape are formed. Plated Ni layers and plated Pd layers are formed by Ni electroplating and Pd electroplating on exposed parts of the liquid crystalline polymer layers 221 and the conductive rubber parts 212 in the openings 275a of the second resist films 275 as shown in FIG. 6(f).

The openings 275a of the second resist patterns 275 are shaped so that the recesses 231 shown in FIG. 3(a) are formed.

Then, the second resist patterns 275 are removed, and exposed parts of the metal layers 230a each consisting of the Cr and the Cu layer are removed by etching using the plated Ni layers and the plated Pd layers as etch-resistant layers as shown in FIG. 6(g).

Then a structure thus formed is subjected to a punching process for shaping and for forming the locating holes 215 and the through holes 216 as shown in FIG. 6(h).

Thus, the inspection contact sheet 210 in Type 1-3 shown in FIG. 3 is completed.

### EXAMPLES

Examples of the inspection contact sheet in the first embodiment of the present invention will be described.

### Example 1-1

An inspection contact sheet 110 in Example 1-1 corresponds to the inspection contact sheet 110 in Type 1-1 shown in FIG. 1(a). The inspection contact sheet 110 in Example 1-1 has an insulating rubber layer 111 formed from a 100 μm thick silicone rubber sheet, insulating protective layers 121 formed from a 25 μm thick polyimide resin film, and conductive rubber parts 112 formed of a cured silver paste containing a silicon rubber as a base material, respectively. A metal layer 113a is a Cu foil of about 18 μm in thickness. A metal layer 113b consists of a 20 μm thick Cu layer, a 5 μm thick Ni layer and a 1.2 μm thick Au layer formed in that order outward by electroplating.

A method of fabricating the inspection contact sheet in Example 1-1 will be described with reference to FIG. 4.

Two two-layer laminated sheets each formed by laminating a 18 μm thick Cu foil and a 25 μm thick polyimide resin film were laminated to both the adhesive surfaces of a 100 μm thick silicon rubber sheet to form a laminated structure, and then the laminated structure was subjected to curing. Thus, a five-layer laminated base sheet 111A consisting of the 18 μm thick Cu foil, the 25 μm thick polyimide resin film, the 100 μm thick silicon rubber sheet, the 25 μm thick polyimide resin film and the 18 μm thick Cu foil as shown in FIG. 4(a) was formed.

The silicon rubber sheet had a Young's modulus of 2 MPa, and a compressive strain limit of 0.6 (=b).

Then, 200 μm diameter through holes 111H were formed in parts of the five-layer laminated base sheet 111A in which the conductive rubber parts (conductive rubber plugs) were to be formed as shown in FIG. 4(b) by laser machining using a UV-YAG laser (third harmonic).

Then, the through holes 111H were filled up with a silicone rubber-base Ag paste containing 90% by weight Ag particles by a screen printing method. The silicone rubber-base Ag paste filling up the through holes 111H was heated for curing at 150° C. for 1 hr to form cured conductive rubber parts.

A test piece formed by molding and curing the silicon rubber-base Ag paste had a volume resistivity of 3×10⁻⁴ Ω·cm, a Young's modulus of 4 MPa and a compressive strain limit of 0.3 (=a).

Parts of the conductive rubber parts of the cured Ag paste protruding from the through holes 111H were removed, and the surfaces of parts of the Cu foils around the conductive rubber parts were polished flat with #600 and #1000 abrasive papers as shown in FIG. 4(c).

Subsequently, 50 μm thick dry resist films were formed over the metal layers, respectively, the dry resist films were subjected to an exposure process and a developing process to form resist patterns having openings coinciding with regions, in which terminal pads or are to be formed. Then, the base sheet was subjected to electroplating using the metal layers as electrodes to form a 20 μm thick plated Cu layer, a 5 μm thick plated Ni layer and a 1.2 μm thick plated Au layer in that order on exposed parts of the Cu foils in the openings in the resist patterns, and on the opposite end surfaces of the conductive rubber parts of the cured Ag paste to form metal layers 113b as shown in FIG. 4(d).

The diameter of the openings was 0.3 mm.

Then, the resist films were removed as shown in FIG. 4(e), and the exposed parts of the Cu foils were removed as shown in FIG. 4(f) by etching using the plated Ni layers and the plated Au layers of the metal layers as etch-resistant layers. An alkaline ammonium persulfate solution was used as an etchant.

Then the base sheet was subjected to a punching process for shaping and forming locating holes 115 to complete an inspection contact sheet 110 shown in FIG. 1(a).

The inspection contact sheet 110 thus fabricated was subjected to a compression test. Each of the conductive rubber parts (conductive rubber plugs) of the inspection contact sheet had a measured resistance of 50 mΩ or below after being compressed 50,000 cycles at a maximum compressive strain ΔH of 50 μm. The compression test proved that the inspection contact sheet was practically satisfactory.

In the inspection contact sheet shown in FIG. 1(a), H1 was 100 μm, H2 was about 186 μm, a was 0.3, b was 0.6, and hence the inspection contact sheet satisfied the conditions: H1>ΔH/b and H2>ΔH/a.

### Example 1-2

An inspection contact sheet 210 in Example 1-2 corresponds to the inspection contact sheet 210 in Type 1-2 shown in FIG. 3. The inspection contact sheet 210 in Example 1-2 has an insulating rubber layer 211, insulating protective layers 221 and conductive rubber parts 212 formed from a 125 μm thick silicone rubber sheet, a 25 μm thick liquid crystalline polymer film, and a cured silver paste containing a silicon rubber as a base material, respectively. Each of first metal layers 230A and 235A are laminated structure consisting of a 0.1 μm thick sputtered Cr layer, a 0.2 μm thick sputtered Cu layer and a 2.0 μm thick plated Ni layer formed in that order. Each of second metal layers 230c and 235c is a laminated structure consisting of a 25 μm thick plated Ni layer and a 0.5 μm thick plated Pd layer formed in that order.

A method of fabricating the inspection contact sheet 210 will be described with reference to FIGS. 5 and 6.

Liquid crystalline polymer layers of 25 μm in thickness were laminated to the adhesive surfaces of a 125 μm thick insulating silicone rubber sheet, the assembly of the liquid crystalline polymer layers and the insulating silicone rubber sheet was heated to form a base sheet, i.e., a three-layer laminated structure consisting of the 25 μm thick liquid crystalline polymer layer, the 125 μm thick silicone rubber sheet and the 25 μm thick liquid crystalline polymer layer as shown in FIG. 5(a).

The silicon rubber sheet had a Young's modulus of 2 MPa and a compressive strain limit of 0.6 (=b).

Then, 250 μm diameter through holes 211H were formed in parts of the three-layer laminated structure in which conductive rubber parts were to be formed as shown in FIG. 5(b) by laser machining using a CO₂ laser.

Then, the through holes 211H were filled up with a silicon rubber-base Ag paste containing 90% by weight Ag particles by a screen printing method, and the Ag paste filling up the through holes 211H was cured at 150° C. for 1 hr.

A test piece formed by molding and curing the silicon rubber-base Ag paste had a volume resistivity of 3×10⁻⁴ Ω·cm, a Young's modulus of 4 MPa and a compressive strain limit of 0.3 (=a).

Parts of the conductive rubber parts of the cured Ag paste protruding from the through holes 211H were removed, and the surfaces of parts of the liquid crystalline polymer layers around the conductive rubber parts were polished flat with #600 and #1000 abrasive papers as shown in FIG. 5(c).

Then, a 0.1 μm thick Cr layer and a 0.2 μm thick Cu layer overlying the Cr layer were formed on both the surfaces of the three-layer laminated structure by a sputtering process as shown in FIG. 5(d).

Metal layers each consisting of the Cr and the Cu layer were used as electrodes for electroplating, and served for firmly bonding the liquid crystalline polymer layers and the conductive rubber parts.

First resist patterns 270 having openings respectively corresponding to regions in which terminal pads or wiring lines were to be formed were formed by processing a 50 μm thick dry resist films formed over the Cu layers formed by a sputtering process, and 2.0 μm thick Ni layers were formed on exposed parts of the Cu layers in the openings by Ni electroplating as shown in FIG. 5(e).

The openings had a diameter of 0.35 mm.

Thus, a first electroplating process was completed.

Then, the first resist pattern 270 were removed, and second-resist patterns 275 provided with openings of a predetermined shape were formed by subjecting a 50 μm thick resist film to exposure and developing processes. Plated Ni layers of 25 μm in thickness and plated Pd layers of 0.5 μm in thickness were formed in that order by Ni electroplating and Pd electroplating on exposed parts of the plated Ni layers in the openings of the second resist pattern 275 to form second metal layers 230c and 235c as shown in FIG. 6(f).

The generally known Watt bath was used for Ni electroplating, and a Pd plating batch commercially available from Riironaru Co. was used for Pd electroplating.

The openings of the second resist pattern were arranged on the plated Ni layers formed by the first electroplating process.

Thus, a second electroplating process was completed.

Then, the second resist patterns 275 were removed, and exposed parts of the Cr layers formed by sputtering and the Cu layers were removed by etching using the plated Ni layers formed by the first electroplating process and the plated Pd layers formed by the second electroplating process as etch-resistant layers as shown in FIG. 6(g).

Then a structure thus formed was subjected to a punching process for shaping to complete an inspection contact sheet 210 as shown in FIG. 3 as shown in FIG. 6(h).

Through holes 216 of 100 μm in diameter were formed near the conductive rubber parts 212, and locating holes 215 were formed in the inspection contact sheet 210 by the punching process.

The inspection contact sheet 210 thus fabricated, similarly to the inspection contact sheet in Example 1-1, was subjected to a compression test. Each of the conductive rubber parts (conductive rubber plugs) of the inspection contact sheet 210 had a measured resistance of 20 mΩ or below after being compressed 50,000 cycles at a maximum compressive strain ΔH of 50 μm. The compression test proved that the inspection contact sheet 210 was practically satisfactory.

In the inspection contact sheet, H1 was 125 μm, H2 was about 175 μm, a was 0.3, b was 0.6 (FIG. 1(a)), and hence the inspection contact sheet 210 satisfied the conditions: H1>ΔH/b and H2>ΔH/a.

The inspection contact sheet of the present invention is an intermediate connecting sheet to be interposed between an electronic device and an electronic device inspecting circuit member to connect the terminals of the electronic device electrically to those of the electronic device inspecting circuit member. Even if a rigid multilayer electronic device inspecting circuit member must be unavoidably used, the inspection contact sheet of the present invention is capable of surely electrically connecting the electronic device and the rigid multilayer electronic device inspecting circuit member, and the method of the present invention is capable of fabricating such a satisfactory inspection contact sheet.

### Second Embodiment

An inspection contact sheet in a second embodiment according to the present invention will be described with reference to the accompanying drawings.

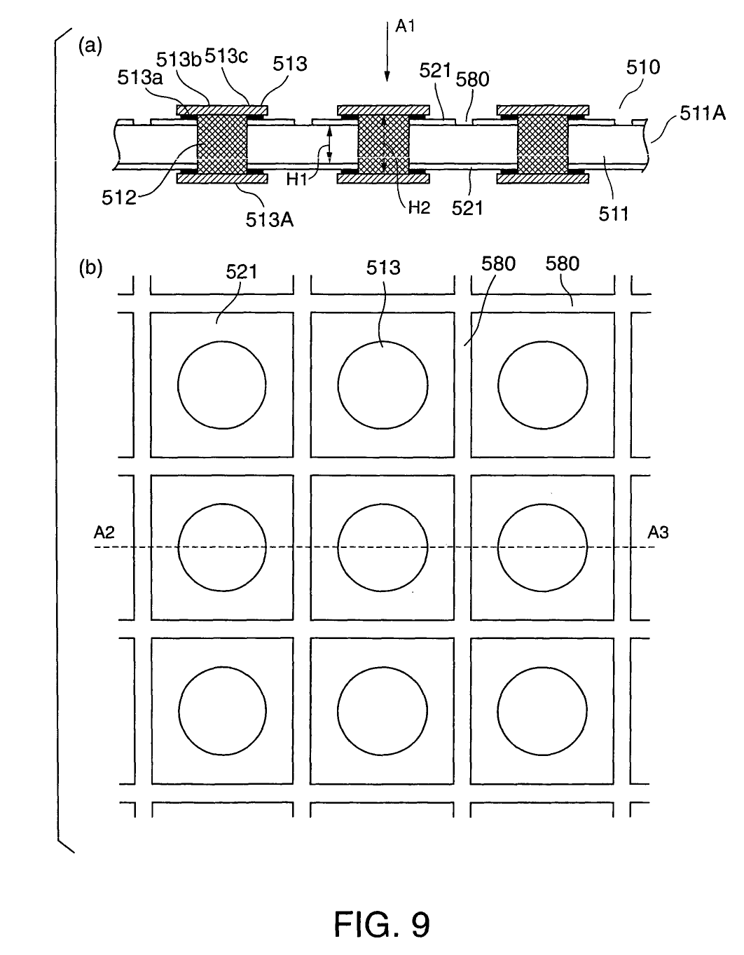

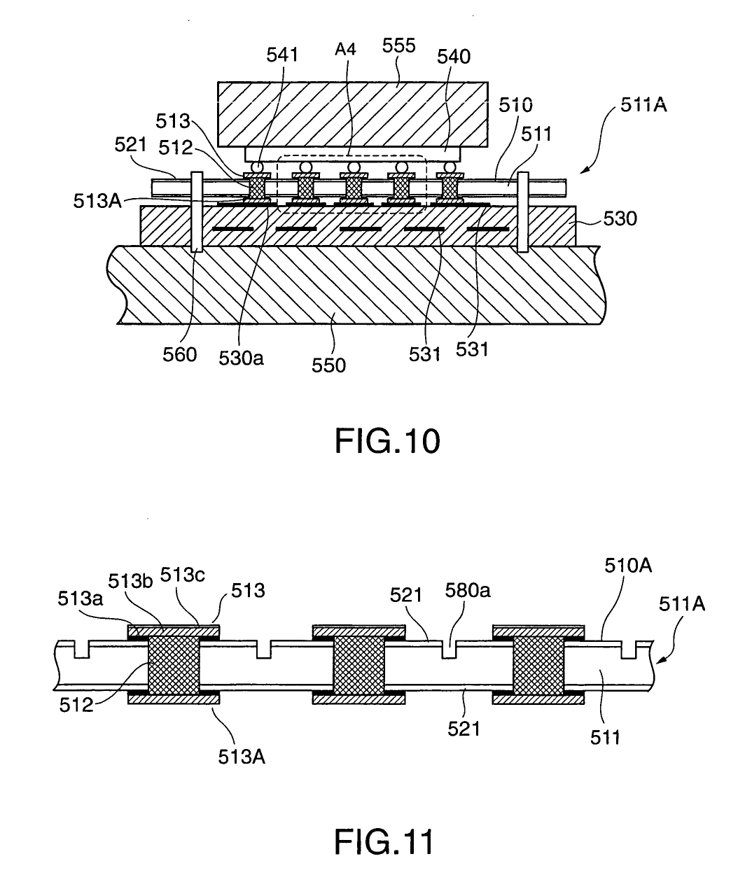

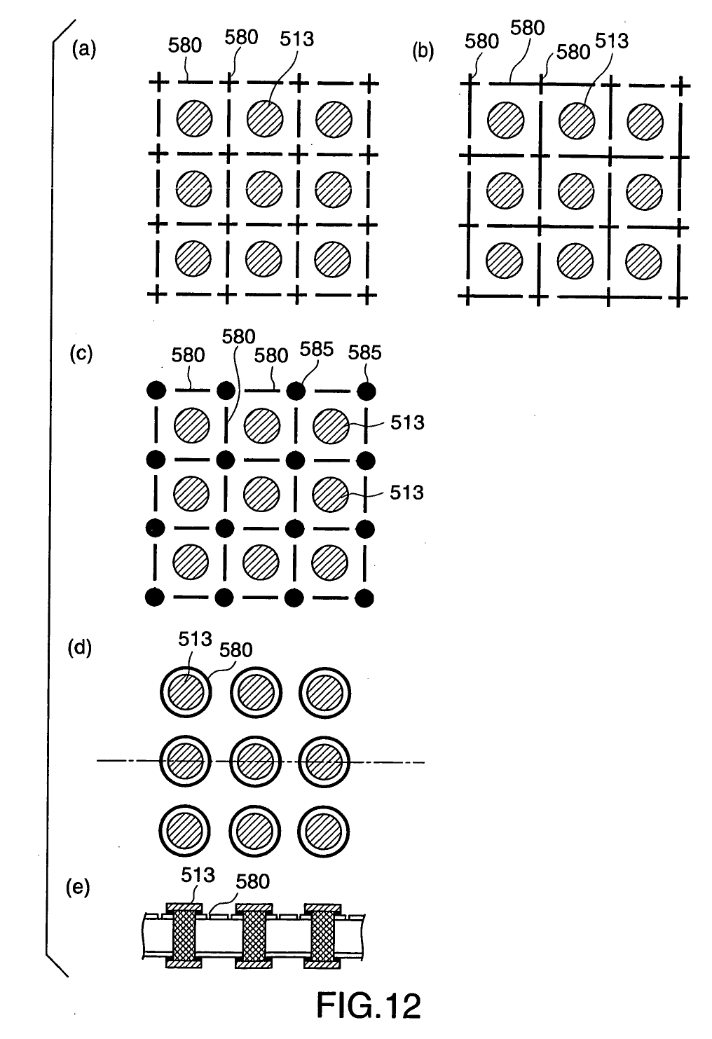

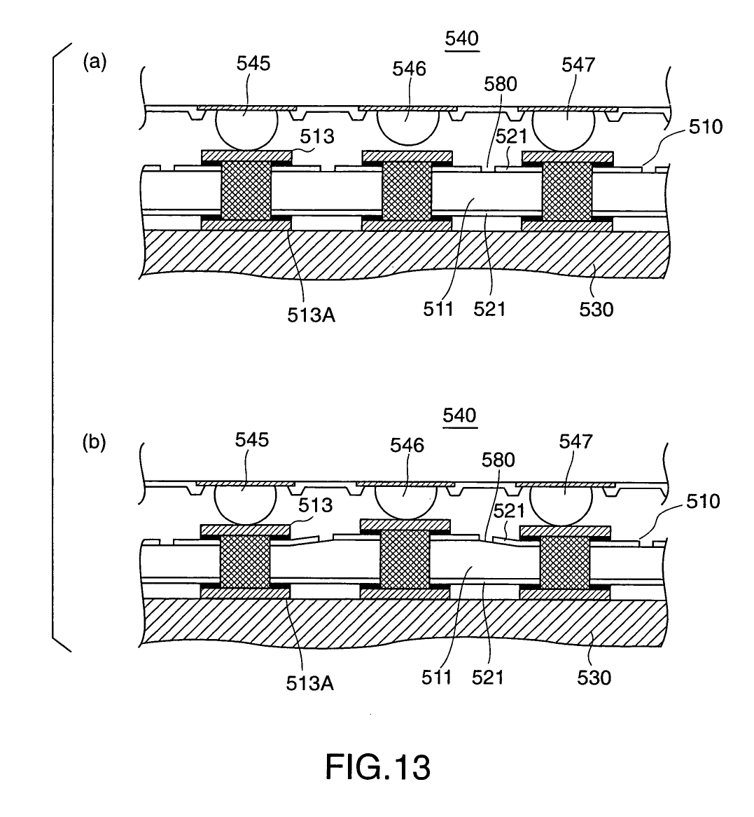

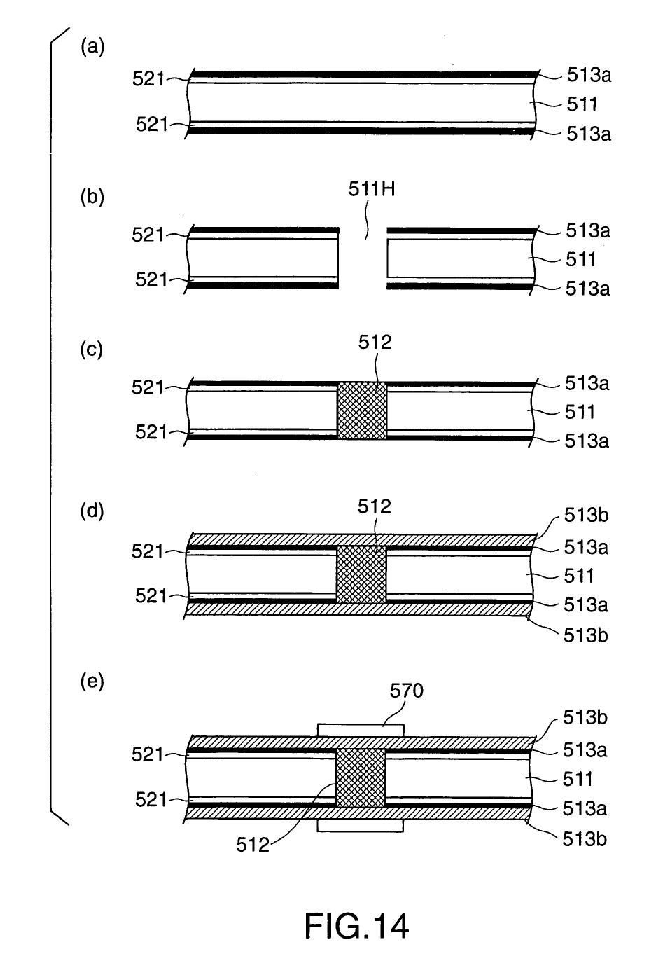

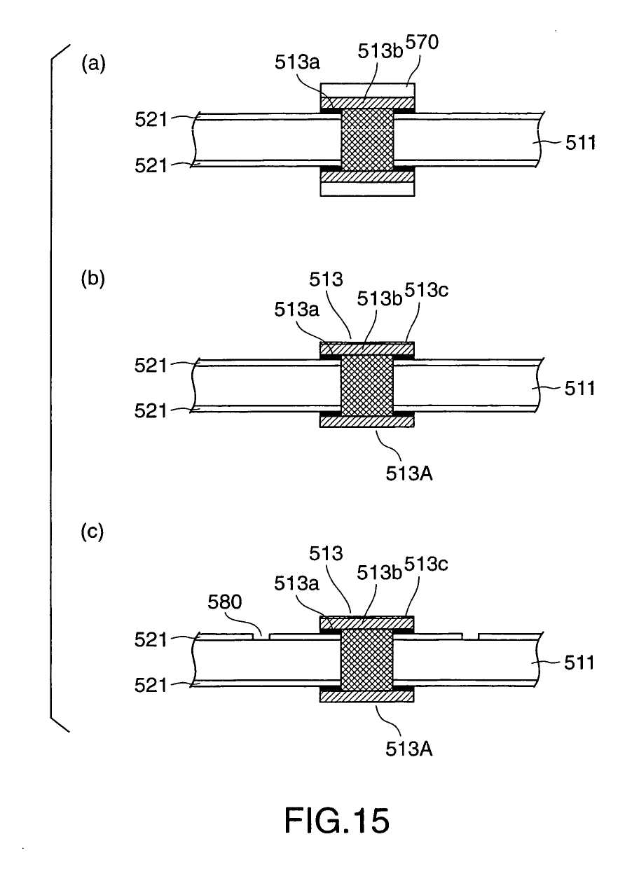

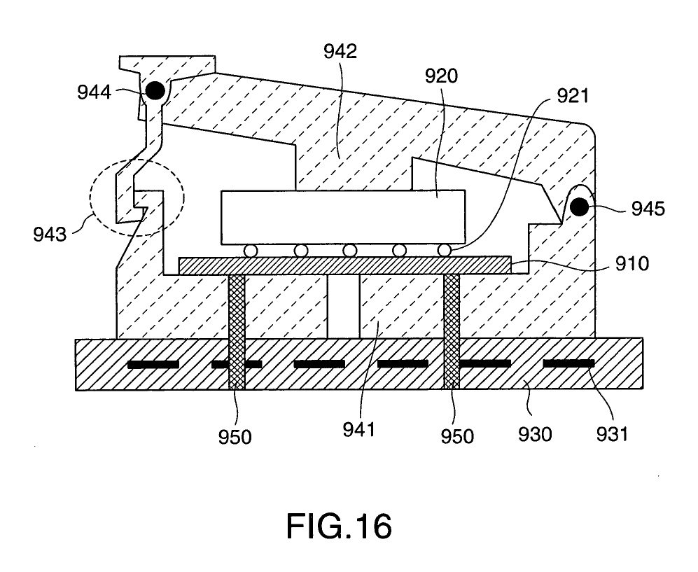

FIG. 9(a) is a partly sectional view of an inspection contact sheet in Type 2-1 in the second embodiment, FIG. 9(b) is a view taken in the direction of the arrow A1 in FIG. 9(a), FIG. 10 is a schematic sectional view showing the inspection contact sheet shown in FIG. 9 in use on an electronic device inspecting device, FIG. 11 is a partly sectional view of an inspection contact sheet in a modification of the inspection contact sheet embodying the present invention, FIGS. 12(a) to 12(e) are views of recesses, FIGS. 13(a) and 13(b) are views of assistance in explaining a mode of contact between the terminals of the inspection contact sheet in Type 2-1 shown in FIG. 9 and the solder balls of an electronic device, FIGS. 14(a) to 14(e) are views of assistance in explaining steps of a method of fabricating the inspection contact sheet in Type 2-1 shown in FIG. 9, and FIGS. 15(f) to 15(h) are views of assistance in explaining steps, following those shown in FIGS. 14(a) to 14(e), of the method of fabricating the inspection contact sheet in Type 2-1 shown in FIG. 9.

FIG. 9(a) is a sectional view taken on the line A2-A3 A3 in FIG. 9(b), and also is an enlarged view of a pat A4 in FIG. 10.

FIG. 10 shows small numbers of terminal pads 513 and 513A and conductive rubber parts 512 to facilitate understanding.

Shown in FIGS. 9 to 15 are inspection contact sheets 510 and 510A, an insulating rubber layer (referred to also as “insulating rubber sheet”) 511, a through hole 511H, a conductive rubber part (referred to also as “conductive rubber plug”) 512, a terminal pad 513 to be brought into contact with a terminal of an electronic device 540, a terminal pad 513A to be brought into contact with a terminal of an electronic device inspecting circuit member 530, a metal layer (Cu foil) 513a, a metal layer (plated Cu layer) 513b, a surface plated layer 513c consisting of a plated Ni layer and a plated Au layer, an insulating protective film (referred to also as “insulating resin layer”), a terminal 530a of the electronic device inspecting circuit member 530, a wiring line 531, a terminal 541 of the electronic device 540, a fixed table 550, a pressing tool 555, a locating pin 560, a resist pattern 570, slits 580 and 580a, and holes 585.

The inspection contact sheet in Type 2-1 in the second embodiment according to the present invention will be described with reference to FIG. 9.

As shown in FIG. 10, the inspection contact sheet 510 in the second embodiment is used on an electronic device inspecting device that holds and compresses the electronic device inspecting circuit member 530 and the electronic device 540 between the fixed table 550 and the pressing tool 555 to connect the electronic device 540 electrically to the electronic device inspecting circuit member 530 for the inspection of the functions and characteristics of the electronic device 540 or for the burn-in test of the electronic device 540. The inspection contact sheet 510 is an intermediate connecting sheet to be interposed between the electronic device 540 and the electronic device inspecting circuit member 530 for the electrical connection of the electronic device 540 and the electronic device inspecting circuit member 530. Referring to FIG. 9(a), the inspection contact sheet 510 comprises a base sheet 511A of three-layer construction including the insulating rubber layer 511 and the insulating protective films 521 covering both the surfaces of the insulating rubber layer 511, and conductive rubber parts 512 having rubber elasticity formed of a rubber-elastic material, extending perpendicularly to the surfaces of the base sheet 511A and penetrating the base sheet 511A. Each conductive rubber part 512 has one end connected to the terminal pad 513 to be connected to a terminal of the electronic device 540, and the other end connected to the terminal pad 513A to be connected to a terminal of the electronic device inspecting circuit member 530. The terminal pads 513 and 513A are connected electrically to the conductive rubber part 512, have areas larger than those of the ends of the conductive rubber part 512, and are capable of covering the ends of the conductive rubber part 512 and areas surrounding the ends of the conductive rubber part 512.

Continuous slits 580 are formed in the insulating protective film 521 so as to surround the terminal pads 513 to be brought into contact with those of the electronic device 540.

The inspection contact sheet 510 in the first embodiment is intended to be used for inspecting a BGA or a CSP provided with solder balls as terminals.

The insulating rubber layer 511 is formed of, for example, a silicone rubber. The insulating rubber layer 511 may be formed of any suitable material other than the silicone rubber.

Materials suitable for forming the insulating rubber layer 511 include fluororubbers, urethane rubbers, polybutadiene rubbers, polyisoprene rubbers, and ethylene-vinyl acetate copolymers.

Preferable materials for forming the insulating protective films 521 are polyimide resins and liquid crystalline polymers. The insulating protective films 521 may be formed of any other suitable materials.

An elastic rubber-like material having rubber elasticity for forming the conductive rubber parts 512 is prepared by dispersing conductive particles in a synthetic rubber. For example, the conductive rubber parts 512 are formed of a cured silver paste containing a silicone rubber as a base material. The conductive rubber parts 512 may be made from any other suitable materials.

Preferably, each conductive part 512 has a resistance of 100 mΩ or below.

The metal layers forming the terminal pads 513 and 513A may be either a single-layer structure or a multilayer structure, and may be formed of any suitable materials. The construction and the material of the metal layers of the terminal pads 513 and 513A are selectively determined depending on a method of forming the same.

For example, when the inspection contact sheet 510 is fabricated by an inspection contact sheet fabricating method illustrated in FIGS. 14 and 15, the metal layer 513b is a plated Cu layer, and the surface plated layer 513c consists of a plated Ni layer and a plated Au layer.

When the inspection contact sheet 510 meets conditions: H1>ΔH/b and H2>ΔH/a, where ΔH is a design maximum compressive deformation of the inspection contact sheet 510 with respect to thickness, a is a compressive strain limit for the conductive rubber parts, b is a compressive strain limit for the insulating rubber layer, H1 is the thickness of the insulating rubber layer, and H2 is the height of the conductive rubber parts, ΔH/H1<b (ΔH/H1 is the compressive strain of the insulating rubber layer) and ΔH/H2<a (ΔH/H2 is the compressive strain of the conductive rubber part). Thus, the insulating rubber layer and the conductive rubber parts are strained for compressive strains below the compressive strain limits, maintain rubber elasticity even if the same are subjected repeatedly to the compressive deformation of ΔH.

Generally, b>a.

The terminal pads 513 to be brought into contact with those of the electronic device 540 are surrounded by the continuous slits 580, respectively. The slits 580 penetrate the insulating protective film 521 of the base sheet 511A. The slits 580 prevent the faulty contact of a small solder ball of an electronic device disposed between large solder balls of the same with the terminal pad 513.

Such a function of the slits 580 will be described in brief with reference to FIG. 13.

In FIG. 13, a small solder ball 546 is disposed between large solder balls 545 and 547.

When inspecting the electronic device 540, the large solder balls 545 and 547 come into contact with the terminal pads 513 facing the electronic device 540 first as shown in FIG. 13(a).

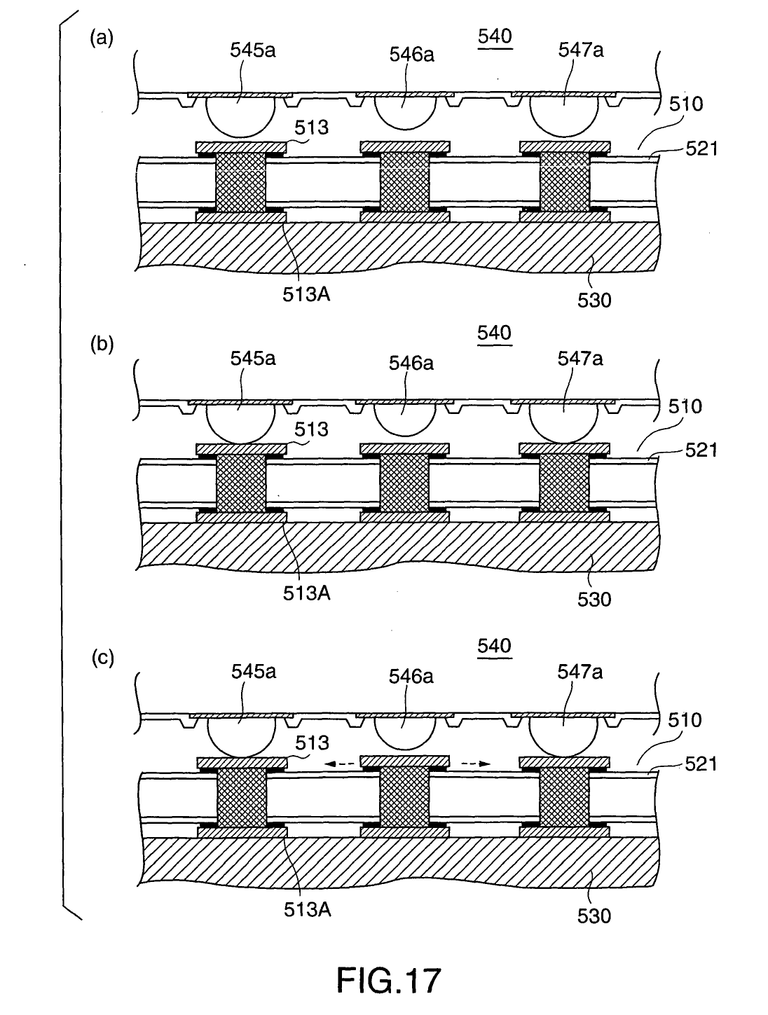

As the pressure applied to the electronic device 540 to press the electronic device 540 against the inspection contact sheet 510 is increased, the terminal pads 513 in contact with the solder balls 545 and 547 are shifted toward the electronic device inspecting circuit member 530. In the second embodiment, the terminal pads 513 to be brought into contact with those of the electronic device 540 are surrounded by the continuous slits 580 penetrating the insulating protective film 521 of the base sheet 511A. Therefore, unlike the terminal pad 513 shown in FIGS. 17(a), 17(b) and 17(c), the terminal pad 513 corresponding to the small solder ball 546 will not be pulled by a part, extending around the same terminal pad 513, of the insulating protective film 521.

In FIGS. 17(a), 17(b) and 17(c), a small solder ball 546a is disposed between large solder balls 545a and 547a. A terminal pad 513 corresponding to the small solder ball 546a is pulled by a part, extending around the same terminal pad 513, of the insulating protective film 521 and is caused to sink.

In FIG. 13, the terminal pad 513 corresponding to the small solder ball 546 is pulled slightly by a part, extending around the same terminal pad 513, of the insulating rubber layer 511 and the insulating rubber layer 511 deforms accordingly. However, the terminal 513 corresponding to the small solder ball 546 is affected scarcely by the positional change of the adjacent terminal pads because the insulating rubber layer 511 deforms.

Consequently, as shown in FIG. 13(b), the small solder ball 546 disposed between the large solder balls 545 and 547 can be satisfactorily brought into contact with the terminal pad 513.

An inspection contact sheet 510A in a modification of the inspection contact sheet in the second embodiment will be described with reference to FIG. 11.

The inspection contact sheet 510A in a modification is provided with continuous slits 580a cut through an insulating protective film 521 bonded to an insulating rubber layer 511 into the insulating rubber layer 511 instead of the continuous slits 580 cut in the insulating protective film 521 of the inspection contact sheet 510 shown in FIG. 9. The inspection contact sheet 510A is similar in other respects to the inspection contact sheet 510 in Type 2-1.

Materials forming the components of the inspection contact sheet 510A in the modification are the same as those forming the components of the inspection contact sheet 510 in Type 2-1, and hence the description thereof will be omitted.

Inspection contact sheets in modifications of the inspection contact sheets 510 shown in FIG. 9 and the inspection contact sheet 510A shown in FIG. 11 are provided with broken slits 580 as shown in FIGS. 12(a) and 12(b), an inspection contact sheet in other modification is provided with broken slits 580 and recesses 585 as shown in FIG. 12(c), and an inspection contact sheet in a further modification is provided with circular slits 580 concentric with the terminal pads 513 as shown in FIGS. 12(d) and 12(e).

Although each of the conductive rubber parts 512 of the inspection contact sheet 510 shown in FIG. 9 has opposite ends connected to the terminal pads 513 and 513A, terminal parts may be separated from the conductive rubber parts 512 in a modification.

Usually, the conductive rubber part 512 is connected to the terminal pad by a wiring line when the terminal pad is separated from the conductive rubber part 512. In such a inspection contact sheet, broken slits are formed in the insulating protective film.

The terminal pads to be brought into contact with the terminals of the electronic device are formed not necessarily in a flat shape.

For example, the terminal pad may have a concave central part or a convex central part, may have a surface coated with a Cu layer, a satin-finished Ni layer or a satin-finished Pd layer formed by electroplating, may have a half-needle-shaped surface.

A method of fabricating the inspection contact sheet 510 shown in FIG. 9 will be described in brief with reference to FIGS. 14 and 15.

An elastic sheet including the insulating rubber layer 511 is formed. Two two-layer laminated sheets each formed by laminating the metal layer 513a, such as a Cu foil, and the insulating protective layer 521 are laminated to both the surfaces of the insulating rubber layer 511, i.e., an elastic sheet, to form a laminated structure with the insulating protective films 521 bonded to the insulating rubber layer 511 as shown in FIG. 14(a), and then the laminated structure is subjected to curing.

Thus, the base sheet, i.e., a five-layer laminated base sheet, including an insulating sheet of three-layer construction consisting of the insulating rubber layer 511 and the insulating protective layers 521 bonded to both the surfaces of the insulating rubber layer 511 is formed.

The metal layers 513a are processed later to form the metal layers 513a of the terminal pads 513 and 513A shown in FIG. 9.

Generally, the two-layer laminated sheet is formed by laminating a metal layer 513a, such as a Cu foil, and an insulating resin layer 521, such as a polyimide resin layer or a liquid crystalline polymer layer.

Then, the through holes 511H are formed in parts of the five-layer laminated base sheet in which the conductive rubber parts are to be formed as shown in FIG. 14(b).

Usually, the through holes 511H are formed by laser machining using a laser, such as a UV-YAG laser.

Then, the through holes 511H are filled up with a conductive rubber paste for forming conductive rubber parts by a screen printing method, a metal mask printing method or a squeegee printing method. The conductive rubber paste filling up the through holes 511H is heated for curing to form cured conductive rubber parts. Parts of the cured conductive rubber parts protruding from the through holes 511H are removed by polishing, and the surfaces of parts of the Cu foils, i.e., the metal layers 513a, around the cured conductive rubber parts are polished as shown in FIG. 14(c).

The conductive rubber paste for forming the conductive rubber parts 512 shown in FIG. 9(a) is prepared by dispersing conductive particles in an elastic synthetic rubber.

The conductive rubber paste is, for example, a silver paste prepared by dispersing Ag particles in a silicone rubber as a base material. Any suitable conductive rubber pastes other than the silver paste may be used.

Thus, the conductive rubber parts 512 shown in FIG. 9(a) are formed.

The opposite end surfaces of each conductive rubber part 512 are flush with the surfaces of the metal layers 513a, respectively.

Then, Cu layers (additional metal layers) 513b are formed over the entire surfaces of the laminated base sheet by electroplating as shown in FIG. 14(d).

Subsequently, dry resist films 570 are formed over the metal layers 513b, respectively, the dry resist films 570 are subjected to an exposure process and a developing process to form resist patterns covering only parts, on which terminal pads are to be formed, of the surfaces of the laminated base sheet as shown in FIG. 14(e). Then, parts of the metal layers 513a and 513b excluding those corresponding to regions in which the terminal pads are to be formed are removed by etching as shown in FIG. 15(a).

The resist films 570 are removed, and Ni layers and Au layers (surface plated layers) 513c are formed by an electroless plating process on the surfaces of terminal forming regions on both the surfaces of the base sheet as shown in FIG. 15(b).

Thus, the terminal pads 513 and 513A are formed.

Then, the continuous slits 580 are formed in the protective film 521 of the base sheet so as to surround the terminal pads 513 to be brought into contact with the terminals of the electronic device as shown in FIG. 15(c) by a laser machining process using a YAG laser.

Conditions of the laser machining process using the YAG laser are controlled properly so that the slits 580 are formed only in the protective film 521 of the base sheet.

Then the base sheet is subjected to a punching process for shaping to obtain the inspection contact sheet 510 shown in FIG. 9(a).

A method of fabricating the inspection contact sheet 510A in the modification shown in FIG. 11 controls the conditions of the laser machining process using the YAG laser shown in FIG. 15(c) so that the slits 580a are cut through the protective film 521 into the insulating rubber layer 511.

The slits shown in FIGS. 12(a) to 12(e) can be formed by controlling the YAG laser so as to emit a laser beam intermittently.

### EXAMPLES

Examples of the inspection contact sheet in the second embodiment of the present invention will be described.

### Example 2-1

An inspection contact sheet in Example 2-1 corresponds to the inspection contact sheet 510 in the second embodiment shown in FIG. 9(a). The inspection contact sheet in Example 2-1 is intended for use for inspecting a BGA provided with 256 pins arranged at pitches of 0.5 mm and having a mean solder ball size of 0.3 mm. The inspection contact sheet in Example 2-1 was fabricated by the method shown in FIGS. 14 and 15.

An inspection contact sheet 510 had a 350 μm thick insulating rubber layer 511 formed from a silicone rubber sheet, 25 μm thick insulating protective layers 521 formed of a polyimide resin, and conductive rubber parts 512 formed by curing a silicone rubber-base Ag paste. Metal layers 513a were about 18 μm thick Cu foils, metal layers 513b were 15 μm thick plated Cu layers, and each of plated surface layers 513c consisted of a 5 μm thick Ni layer formed by electroless plating and a 0.2 μm thick plated Au layer formed in that order.

The method of fabricating the inspection contact sheet 510 will be described with reference to FIGS. 14 and 15.

Two two-layer laminated sheets each formed by laminating an 18 μm thick Cu foil, and a 25 μm thick polyimide resin layer were laminated to both the surfaces of the adhesive surfaces of a 350 μm thick silicone rubber sheet to form a five-layer laminated structure as shown in FIG. 14(a), and then the five-layer laminated structure was subjected to curing.

The silicone rubber sheet had a Young's modulus of 3.4 MPa and a compressive strain limit of 0.4.

Then, 200 μm diameter through holes 511H were formed in parts of the five-layer laminated base sheet in which the conductive rubber parts were to be formed by laser machining using a UV-YAG laser as shown in FIG. 14(b).

Then, the through holes 511H were filled up with a silicone rubber-base Ag paste containing 90% by weight Ag particles by a squeegee printing method. The silicone rubber-base Ag paste filling up the through holes 511H was cured at 150° C. for 1 hr to form cured conductive rubber parts.

A test piece formed by molding and curing the silicon rubber-base Ag paste had a volume resistivity of 3×10⁻⁴ Ω·m, a Young's modulus of 1.5 MPa and a compressive strain limit of 0.3.

Parts of the conductive rubber parts of the cured Ag paste protruding from the through holes 111H were removed, and the surfaces of parts of the Cu foils around the conductive rubber parts were polished flat with #600 and #1000 abrasive papers as shown in FIG. 14(c).

Then, 15 μm thick Cu layers were formed over the entire surfaces of the laminated base sheet by electroplating as shown in FIG. 14(d).

Subsequently, dry resist films 570 were formed over the Cu layers, respectively, the dry resist films 570 were subjected to an exposure process and a developing process to form resist patterns covering only parts, on which terminal pads were to be formed, of the surfaces of the laminated base sheet as shown in FIG. 14(e). Then, parts of the metal layers 513a and 513b excluding those corresponding to regions in which the terminal pads were to be formed were removed by etching as shown in FIG. 15(a).

A ferric chloride solution was used as an etchant.

The diameters of the terminal forming regions were 0.3 mm.

The resist films 570 were removed, and 5 μm thick Ni layers and 0.2 μm thick Au layers were formed by an electroless plating process on the surfaces of the terminal forming regions on both the surfaces of the base sheet as shown in FIG. 15(b).

Thus, terminal pads 513 and 513A were formed.

Then, continuous slits 580 were formed in the protective film 521 of the base sheet so as to surround the terminal pads 513 to be brought into contact with the terminals of the electronic device as shown in FIG. 15(c) by a laser machining process using a YAG laser.

Then the base sheet was subjected to a punching process for shaping and for forming locating holes, not shown. Thus, the inspection contact sheet 510 in Example 2-1 corresponding to the inspection contact sheet shown in FIG. 9(a) was completed.

The inspection contact sheet 510 was subjected to a performance test. The inspection contact sheet 510 was held fixedly on an electronic device inspecting circuit member 530 on an electronic device inspecting device shown in FIG. 10. The BGA provided with 256 pins arranged at pitches of 0.5 mm and having a mean solder ball size of 0.3 mm was moved gradually toward the inspection contact sheet 510 as shown in FIG. 13 and contact resistances between the terminal pads and the solder balls respectively touching the terminal pads were measured.

When a pressure of 5 kg (19.5 g per solder ball) was applied to the BGA, the BGA sunk 65 μm. Each of the measured contact resistances between each solder ball and the terminal pad in touch with the solder ball was 75±20 mΩ.

The diameters of the solder balls of the BGA were 0.3±0.05 mm.

In the inspection contact sheet in Example 2-1, a=0.3, b=0.4, H1=0.35 mm, H2=0.436 mm, ΔH=0.065 mm, and the inspection contact sheet satisfied the conditions: H1>ΔH/b and H2>ΔH/a.

An inspection contact sheet in a comparative example not provided with any slits and similar in construction to the inspection contact sheet in Example 2-1 was fabricated and was subjected to the same performance test. The BGA sunk 55 μm, and each of the measured contact resistances between each solder ball and the terminal pad in contact with the solder ball was 165±85 mΩ. It was proved that the slits increase the sinkage of the electronic device, and reduce contact resistance and narrow the range dispersion of contact resistances.

As apparent from the foregoing description, the inspection contact sheet of the present invention is an intermediate connecting sheet to be interposed between an electronic device and an electronic device inspecting circuit member to connect the terminals of the electronic device electrically to those of the electronic device inspecting circuit member. The inspection contact sheet is capable of surely electrically connecting the test electronic device and the electronic device inspecting circuit member. The inspection contact sheet withstands repetitive use and is excellent in quality. Even if a rigid multilayer electronic device inspecting circuit member must be unavoidably used, the inspection contact sheet of the present invention is capable of surely electrically connecting the electronic device and the rigid multilayer electronic device inspecting circuit member. The inspection contact sheet is capable of solving problems that arise when solder balls of different sizes serving as terminals are arranged at small pitches, and small solder balls adjacent to large solder balls have difficulty in coming into contact with the terminals of the inspection contact sheet.

1. An inspection contact sheet to be interposed between an electronic device and an electronic device inspecting circuit member to connect the electronic device electrically to the electronic device inspecting circuit member, said inspection contact sheet comprising:
an insulating rubber layer having rubber elasticity;
a pair of insulating protective films bonded to both the surfaces of the insulating rubber layer;
conductive rubber parts formed of a conductive rubber-like material having rubber elasticity, and penetrating the insulating rubber layer and the pair of protective films and; and
terminal pads or wiring lines connected to the opposite ends of each of the conductive rubber parts.

2. The inspection contact sheet according to claim 1, wherein
the terminal pads or the wiring lines have an area greater than the sectional area of the conductive rubber parts, and cover the ends of the conductive rubber parts entirely.

3. The inspection contact sheet according to claim 2, wherein
each of the terminal pads on the side of the electronic device has an inner first metal layer and an outer second metal layer, and the second meal layer is provided with a central recess.

4. The inspection contact sheet according to claim 2, wherein
through holes penetrating the insulating rubber layer and the pair of protective layers are formed near the conductive rubber parts.

5. The inspection contact sheet according to claim 2, wherein
the conductive rubber parts are formed of a conductive material prepared by dispersing conductive particles in a silicone rubber,
the insulating rubber layer is formed of a silicone rubber, and the insulating protective films are formed of a polyimide resin or a liquid crystalline polymer.

6. The inspection contact sheet according to claim 5, wherein
the conductive particles are Ag particles.

7. The inspection contact sheet according to claim 2, wherein
H1>ΔH/b and H2>ΔH/a, where ΔH is a maximum compressive deformation of the inspection contact sheet with respect to the direction of thickness, a is a compressive strain limit for the conductive rubber parts, b is a compressive strain limit for the insulating rubber layer, H1 is the thickness of the insulating rubber layer, and H2 is the height of the conductive rubber parts.

8. The inspection contact sheet according to claim 1, wherein
the protective film on the side of the electronic device is provided with slits formed so as to surround the terminal pads.

9. The inspection contact sheet according to claim 8, wherein
the terminal pads or the wiring lines have an area greater than the sectional area of the conductive rubber parts and cover the ends of the conductive rubber parts entirely.

10. The inspection contact sheet according to claim 8, wherein
the conductive rubber parts are formed of a conductive material prepared by dispersing conductive particles in a silicone rubber,
the insulating rubber layer is formed of a silicone rubber, and the insulating protective films are formed of a polyimide resin or a liquid crystalline polymer.

11. The inspection contact sheet according to claim 8, wherein the
conductive particles are Ag particles.

12. The inspection contact sheet according to claim 8, wherein
H1>ΔH/b and H2>ΔH/a, where ΔH is a maximum compressive deformation of the inspection contact sheet with respect to the direction of thickness, a is a compressive strain limit for the conductive rubber parts, b is a compressive strain limit for the insulating rubber layer, H1 is the thickness of the insulating rubber layer, and H2 is the height of the conductive rubber parts.

13. The inspection contact sheet according to claim 8, wherein
each of the terminal pads on the side of the electronic device is provided with a central recess.

14. The inspection contact sheet according to claim 8, wherein
the electronic device is a GBA or a CSP provided with solder balls.

15. A method of fabricating an inspection contact sheet comprising the steps of:
forming a five-layer laminated structure having a metal layer, an protective layer, an insulating rubber layer, a protective layer and a metal layer superposed in that order by laminating two-layer structures each consisting of the metal layer for forming terminal pads, and the insulating protective layer to both the adhesive surfaces of the insulating rubber layer, and heating the laminated structure formed by laminating the two-layer structures to both the adhesive surfaces of the insulating rubber layer;
forming through holes in the five-layer laminated structure;
filling the through holes with a conductive rubber paste and curing the conductive rubber paste filling up the through holes to form conductive rubber parts having rubber elasticity;
removing parts of the conductive rubber parts projecting from the surfaces of the five-layer laminated structure by polishing;
forming resist films having openings corresponding to the opposite ends of the conductive rubber parts and parts of the metal layers around the opposite ends of the conductive rubber parts;
forming laminated films or single-layer films having an etch-resistant metal by plating on the opposite ends of the conductive rubber parts and the exposed parts of the metal layers to form terminal pads or wiring lines; and
removing the resist films and removing exposed parts of the metal layers by etching using the terminal pads or the wiring lines as etch-resistant layers.

16. A method of fabricating an inspection contact sheet comprising the steps of:
forming a three-layer laminated structure having an insulating protective layer, an insulating rubber layer having adhesive surfaces, and an insulating protective layer superposed in that order by laminating the insulating protective layers to both the adhesive surfaces of the insulating rubber layer, and heating the laminated structure formed by laminating the insulating protective layers and the insulating rubber layer;
forming through holes in the three-layer laminated structure;
filling up the through holes with a conductive rubber paste and curing the conductive rubber paste filling up the through holes to form conductive rubber parts having rubber elasticity;
removing parts of the conductive rubber parts projecting from surfaces of the three-layer laminated structure by polishing;
forming metal layers on both the surfaces of the three-layer laminated structure by a sputtering process or an ion plating process;
forming first resist films having first openings on the metal layers, and forming an etch-resistant metal layer on parts of the metal layers corresponding to the first openings of the first resist films by a first electroplating process;
removing the first resist films, forming second resist films having second openings, and forming laminated layers each having an outermost etch-resistant metal layer, or a single-layer metal layers by plating on parts of the etch-resistant metal layers corresponding to the second openings to form terminal pads or wiring lines; and
removing the second resist films, and removing exposed parts of the metal layers by etching using the terminal pads or the wiring lines as etch-resistant layers.

17. A method of fabricating an inspection contact sheet comprising the steps of:
forming a five-layer laminated structure having a metal layer, an protective layer, an insulating rubber layer, a protective layer and a metal layer superposed in that order by laminating two-layer structures each consisting of the metal layer for forming terminal pads, and the insulating protective layer to both the adhesive surfaces of the insulating rubber layer, and heating the laminated structure formed by laminating the two-layer structures to both the adhesive surfaces of the insulating rubber layer;
forming through holes in the five-layer laminated structure;
filling the through holes with a conductive rubber paste and curing the conductive rubber paste filling up the through holes to form conductive rubber parts having rubber elasticity;
removing parts of the conductive rubber parts projecting from the surfaces of the five-layer laminated structure by polishing;
forming additional metal layers on both the surface metal layers and on the surfaces of the conductive rubber parts by a plating process;
forming resist films covering only regions in the surfaces of the additional metal layers corresponding to terminal pads or wiring lines, and removing exposed parts of the additional metal layers and the metal layers by etching; and
removing the resist films and forming plated layers on regions of the surfaces of the additional metal layers corresponding to the terminal pads or the wiring lines by an electroless plating; and
forming slits in the protective film on the side of the electronic device so as to surround the terminal pads to be brought into contact with those of the electronic device, respectively, by laser machining.

18. The method of fabricating an inspection contact sheet for electronic device inspection according to any one of claims 15 to 17, wherein
the conductive rubber paste is prepared by dispersing conductive particles, such as Ag particles, in a silicone rubber, the insulating rubber layer is formed of a silicone rubber, and the insulating protective films are formed of a polyimide resin or a liquid crystalline polymer.

19. The method of fabricating an inspection contact sheet according to any one of claims 15 to 17, wherein
H1>ΔH/b and H2>ΔH/a, where ΔH is a maximum compressive deformation of the thickness of the inspection contact sheet with respect to the direction of thickness, a is a compressive strain limit for the conductive rubber parts, b is a compressive strain limit for the insulating rubber layer, H1 is the thickness of the insulating rubber layer, and H2 is the height of the conductive rubber parts.
